(19) United States
(12) Patent Application Publication
(10) Pub. No.: US 2025/0360653 A1
(43) Pub. Date: Nov. 27, 2025

(54) CENTERLESS SINTERING SETTERS

(71) Applicant: QUANTUMSCAPE BATTERY, INC., San Jose, CA (US)

(72) Inventors: Niall DONNELLY, San Jose, CA (US); Saranya VENUGOPAL, San Jose, CA (US); Lakshmi RAMADAS, San Jose, CA (US); John GOLDSBERRY, San Jose, CA (US)

(21) Appl. No.: 19/294,094

(22) Filed: Aug. 7, 2025

Related U.S. Application Data
(63) Continuation of application No. PCT/US2024/015067, filed on Feb. 8, 2024.
(60) Provisional application No. 63/484,924, filed on Feb. 14, 2023.

(51) Int. Cl. B28B 7/42

(52) U.S. Cl. CPC B28B 7/42

(57) ABSTRACT

Set forth herein are materials, systems, and methods for sintering bilayers that include a layer of a metal and a layer of a ceramic.

### CROSS-REFERENCE TO RELATED APPLICATIONS

This application is a continuation of International Patent Application No. PCT/US2024/015067, filed Feb. 8, 2024, which claims priority to, and the benefit of, U.S. Provisional Patent Application No. 63/484,924, filed Feb. 14, 2023, the entire contents of which are herein incorporated by reference in its entirety for all purposes.

### FIELD

The present disclosure concerns methods of sintering oxides and related materials as well as systems and materials for use with the same.

### BACKGROUND OF THE INVENTION

Ion (e.g., Li⁺) mobility is typically lower in solid-state electrolytes compared to ion mobility in conventionally used, flammable, liquid electrolytes. To compensate for this lower ion mobility, solid-state electrolytes are fabricated as thin films. A thin film reduces the distance that ions conduct through the solid-state electrolyte to the thickness of the film. The ion conduction distance in a thin film solid-state electrolyte is less than the ion conduction distance in liquid electrolytes. As a result, solid-state electrolytes, when used in rechargeable battery cells, can provide energy delivery rates (i.e., power) comparable to, or superior to, the energy delivery rates of batteries that use liquid electrolytes.

However, challenges remain in the fabrication of a solid-state electrolytes that are thinner than approximately 100 microns (μm). For example, cracks, voids, and other inhomogeneities may form during fabrication. Such cracks, voids, and other inhomogeneities may be detrimental to the performance of thin solid-state electrolyte in a battery cell.

Set forth herein are solutions to the challenges relating to the fabrication of solid-state electrolytes as well as others in the field to which the instant disclosure pertains.

### SUMMARY OF THE INVENTION

The present disclosure relates generally to the fabrication of components for lithium rechargeable batteries. Specifically, the present disclosure relates to the fabrication of setter plates for sintering solid-state electrolytes and bilayers that include solid-state electrolytes. In some embodiments, the setter plates described herein are useful for preparing thin, dense bilayers that include a layer of a solid-state electrolyte and a layer of metal and wherein the solid-state electrolyte has a high Li⁺ ion conductivity and a low area-specific resistance (ASR).

In one embodiment, set forth herein is a stack including: a bottom setter including at least one or more refractory materials; a bilayer disposed on the bottom setter, wherein the bilayer includes: a layer including an oxide, and a layer including a metal; a top setter disposed on the bilayer, wherein the top setter has a perimeter but does not have a center.

In another embodiment, set forth herein is a stack including: a bottom setter; a bilayer disposed on the bottom setter, wherein the bilayer includes: a layer including an oxide, and a layer including a metal; a metallic mesh disposed on the electrolyte bilayer.

In yet another embodiment, set forth herein is a stack including: a bottom setter; a bilayer disposed on the bottom setter, wherein the bilayer includes: a layer including an oxide, and a layer including a metal; at least one or more shims including a refractory material disposed above the bilayer.

In still another embodiment, set forth herein is a stack including: a bottom setter; a bilayer disposed on the bottom setter, wherein the bilayer includes: a layer including an oxide, and a layer including a metal; at least one or more shims including a refractory material disposed around the bilayer.

### BRIEF DESCRIPTION OF DRAWINGS

FIG. 1 illustrates certain forces present when sintering tape-casted ceramics between setter plates.

FIG. 2 illustrates an embodiment of a setter stack disclosed herein.

FIG. 3 illustrates an embodiment of a setter stack disclosed herein.

FIG. 4 illustrates an embodiment of a setter stack disclosed herein.

FIG. 5 illustrates an embodiment of a setter stack disclosed herein.

FIG. 6 illustrates an embodiment of a setter stack disclosed herein.

FIG. 7 illustrates an embodiment of a setter stack disclosed herein.

### DETAILED DESCRIPTION OF THE INVENTION

Set forth herein is equipment and processes useful for achieving high quality, rapidly processed ceramic electrolyte films. Set forth herein are high-throughput continuous processes for sintering thin film ceramics. The ceramics may include, but are not limited to, lithium aluminum titanium phosphate (LATP), lithium-stuffed garnet oxides (e.g., Li₇La₃Zr₂O₁₂ and Li₇La₃Zr₂O₁₂Al₂O₃; aka LLZO), lithium lanthanum titanate, and lithium aluminum germanium phosphate (LAGP). The processes include, in certain embodiments, sintering steps in which the parts of the sintering film (i.e., the center section of a green film or green body on a bilayer which is undergoing the process of becoming a sintered film or sintered bilayer) is not in contact with any surface as it sinters. In some embodiments, when a bilayer is used, the metal layer may contact surfaces, but center portions of the green body will not contact surfaces of the processing apparatus, such as a setter. By sintering without contacting a setter during sintering, the portions of the sintered ceramic films prepared by the instant process have unexpectedly advantageous properties such as low flatness. For lithium-stuffed garnet, the processing apparatus has the unexpectedly advantageous property of permitting the retention of the stoichiometric amount of lithium in a given LLZO formula and advantageous LLZO microstructure (e.g., high density, small grain size, and combinations thereof). In some embodiments, by using the setters and stacks disclosed herein, the materials prepared lack surface flaws. In some embodiments, by using the setters and stacks disclosed herein, the bilayers prepared herein lack surface flaws on the ceramic side of the bilayer.

Set forth herein are processes for continuously processing a bilayer include a step 1) binder burn-out (BBO), which occurs between room temperature and moderately high temperature, in order to remove the organic material from the bilayer, and step 2) sintering, which at very high temperature, to transform the ceramic powder into a dense solid.

In both stages as well as during the cool down to room temperature afterwards, the temperature profile and gas environment are controlled.

In some processes, herein, both processing stages (BBO and Sintering), occur in a single tool. In other embodiments, a separate tool is used for each stage, i.e., one tool for BBO and one tool for Sintering. For example, one setter stack may be used to calcine and sinter the green body of a bilayer.

### Definitions

The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present disclosure is not intended to be limited to the embodiments presented but is to be accorded the widest scope consistent with the principles and novel features disclosed herein.

In the following detailed description, numerous specific details are set forth in order to provide a more thorough understanding of the present invention. However, it will be apparent to one skilled in the art that the present disclosure may be practiced without necessarily being limited to these specific details. In other instances, well-known structures and devices are shown in block diagram form, rather than in detail, in order to avoid obscuring the instant disclosure.

All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

As used herein, the term “about,” when qualifying a number, e.g., about 15% w/w, refers to the number qualified and optionally the numbers included in a range about that qualified number that includes ±10% of the number. For example, about 15% w/w includes 15% w/w as well as 13.5% w/w, 14% w/w, 14.5% w/w, 15.5% w/w, 16% w/w, or 16.5% w/w. For example, “about 75° C.,” includes 75° C. as well 68° C., 69° C., 70° C., 71° C., 72° C., 73° C., 74° C., 75° C., 76° C., 77° C., 78° C., 79° C., 80° C., 81° C., 82° C., or 83° C.

As used herein, “selected from the group consisting of” refers to a single member from the group, more than one member from the group, or a combination of members from the group. A member selected from the group consisting of A, B, and C includes, for example, A only, B only, or C only, as well as A and B, A and C, B and C, as well as A, B, and C.

As used herein the phrase “solid separator” refers to a Li⁺ ion-conducting material that is substantially insulating to electrons (e.g., the lithium-ion conductivity is at least 103 times, and often 106 times, greater than the electron conductivity), and which acts as a physical barrier or spacer between the positive and negative electrodes in an electrochemical cell.

As used herein, area-specific resistance (ASR) is measured by electrochemical cycling using an Arbin, Maccor, or Biologic instrument unless otherwise specified to the contrary.

As used herein, ionic conductivity is measured by electrical impedance spectroscopy methods known in the art.

As used herein, the term “electrolyte” refers to an ionically conductive and electrically insulating material. Electrolytes are useful for electrically insulating the positive and negative electrodes of a rechargeable battery while allowing for the conduction of ions, e.g., Lit, through the electrolyte.

As used here, the phrase “solid-state electrolyte separator,” or “solid-state separator,” or “solid-state separator,” is used interchangeably with the phrase “solid separator” refers to a material which does not include carbon and which conducts atomic ions (e.g., Li⁺) but does not conduct electrons. A solid-state electrolyte separator is a solid material suitable for electrically isolating the positive and negative electrodes of a lithium secondary battery while also providing a conduction pathway for lithium ions. Example inorganic solid-state electrolytes include oxide electrolytes and sulfide electrolytes, which are further defined below. Non-limiting examples of sulfide electrolytes are found, for example, in U.S. Pat. No. 9,172,114, which issued Oct. 27, 2015, and also in US Patent Application Publication No. 2017-0162901 A1, which published Jun. 8, 2017, the entire contents of which are herein incorporated by reference in its entirety for all purposes. Non-limiting example oxide electrolytes are found, for example, in US Patent Application Publication No. 2015-0200420 A1, which published Jul. 16, 2015, the entire contents of which are herein incorporated by reference in its entirety for all purposes. In some examples, the inorganic solid-state electrolyte also includes a polymer and is referred to as a composite electrolyte. Composite electrolytes are found for example in U.S. Pat. No. 9,666,870, the entire contents of which are herein incorporated by reference in its entirety for all purposes.

As used herein, the phrase “film thickness” refers to the distance, or median measured distance, between the top and bottom faces of a film. As used herein, the top and bottom faces refer to the sides of the film having the largest geometric surface area, wherein the geometric surface area is calculated by multiplying the face length by its width. As used herein, thickness is measured by cross-sectional scanning electron microscopy.

As used herein, the phrase “film” or “thin film” refers to a thin membrane of less than 0.5 mm in thickness and greater than 10 nm in thickness. A thin film is also greater than 5 mm in a lateral dimension. A “film” or “thin-film” may be produced by a continuous process such as tape-casting, slip casting, or screen-printing. A thin film has thickness between 1 μm and 100 μm unless stated otherwise.

As used herein, “thin” means, when qualifying a solid-state electrolyte, a thickness dimension less than 200 μm, sometimes less than 100 μm and in some cases between 0.1 and 60 μm, and in other cases between about 10 nm to about 100 μm; in other cases, about 1 μm, 10 μm, or 50 μm in thickness.

As used herein, “sintered thin film,” refers to a thin film that has been sintered, e.g., heated above 1000° C. to densify its structure without changing its chemical composition.

As used herein, “binder” refers to a polymer with the capability to increase the adhesion and/or cohesion of material, such as the solids in a green tape. Suitable binders may include, but are not limited to, PVDF, PVDF-HFP, SBR, and ethylene alpha-olefin copolymer. A “binder” refers to a material that assists in the adhesion of another material. For example, as used herein, polyvinyl butyral is a binder because it is useful for adhering garnet materials. Other binders may include polycarbonates. Other binders may include poly acrylates and poly methacrylates. These examples of binders are not limiting as to the entire scope of binders contemplated here but merely serve as examples. Binders useful in the present disclosure include, but are not limited to, polypropylene (PP), polyethylene, atactic polypropylene (aPP), isotactic polypropylene (iPP), ethylene propylene rubber (EPR), ethylene pentene copolymer (EPC), polyisobutylene (PIB), styrene butadiene rubber (SBR), polyolefins, polyethylene-co-poly-1-octene (PE-co-PO), polyethylene-co-poly(methylene cyclopentane) (PE-co-PMCP), poly(methyl methacrylate) (PMMA), acrylics,
polyvinylacetacetal resin,
polyvinyl butyral resin, PVB, stereoblock polypropylenes, polypropylene polymethylpentene copolymer, polyethylene oxide (PEO), PEO block copolymers, silicone, polyacrylonitrile (PAN), polyvinyl chloride (PVC), polyvinyl pyrrolidone (PVP), polyethylene oxide poly(allyl glycidyl ether) PEO-AGE, polyethylene oxide 2-methoxy ethoxy ethyl glycidyl ether (PEO-MEEGE),
polyethylene oxide 2-methoxyethoxyethyl glycidyl poly(allyl glycidyl ether) (PEO-MEEGE-AGE), polysiloxane, polyvinylidene fluoride (PVDF), polyvinylidene fluoride hexafluoropropylene (PVDF-HFP), nitrile rubber (NPR), polybutadiene polymer,
polybutadiene rubber (PB), polyisobutadiene rubber (PIB), polyolefin, alpha-polyolefin,
ethylene alpha-polyolefin, polyisoprene rubber (PI), polychloroprene rubber (CR),
acrylonitrile-butadiene rubber (NBR), and polyethyl acrylate (PEA), and the like.

As used herein, the phrases “electrochemical cell” or “battery cell” shall mean a single cell including a positive electrode and a negative electrode, which have ionic communication between the two using an electrolyte. In some embodiments, the same battery cell includes multiple positive electrodes and/or multiple negative electrodes enclosed in one container.

As used herein the phrase “electrochemical stack,” refers to one or more units which each include at least a negative electrode (e.g., Li, LiC₆), a positive electrode (e.g., FeF₃, NiFₓ wherein x is 2 or 3, nickel-cobalt aluminum oxide NCA, lithium iron phosphate (LFP), LiNiₓMn_{y}Co_{z}O₂, [NMC] or LiNiₓAl_{y}Co_{z}O₂ [NCA], wherein x+y+z=1; and wherein 0≤x≤1; 0≤y≤1; and 0≤z≤1), optionally combined with a solid-state electrolyte or a gel electrolyte), and a solid-state electrolyte (e.g., an oxide electrolyte set forth herein such as a lithium-stuffed garnet (Li₇La₃Zr₂O₁₂)) between and in contact with the positive and negative electrodes. In some examples, between the solid-state electrolyte and the positive electrode, there is an additional layer comprising a compliant material (e.g., gel electrolyte). An electrochemical stack may include one of these aforementioned units. An electrochemical stack may include several of these aforementioned units arranged in electrical communication (e.g., serial or parallel electrical connection). In some embodiments, when the electrochemical stack includes several units, the units are layered or laminated together in a column. In some embodiments, when the electrochemical stack includes several units, the units are layered or laminated together in an array. In some embodiments, when the electrochemical stack includes several units, the stacks are arranged such that one negative electrode is shared with two or more positive electrodes. Alternatively, in some embodiments, when the electrochemical stack includes several units, the stacks are arranged such that one positive electrode is shared with two or more negative electrodes. Unless specified otherwise, an electrochemical stack includes one positive electrode, one solid-state electrolyte, and one negative electrode, and optionally includes a bonding layer between the positive electrode and the solid electrolyte.

As used here, the phrase “positive electrode,” refers to the electrode in a secondary battery towards which positive ions, e.g., Lit, conduct, flow, or move during discharge of the battery.

As used herein, the phrase “negative electrode” refers to the electrode in a secondary battery from where positive ions, e.g., Li⁺ flow, or move during discharge of the battery. A negative electrode that includes lithium metal is referred to herein as a lithium metal negative electrode.

In a battery comprised of a Li-metal electrode and a conversion chemistry, intercalation chemistry, or combination of conversion/intercalation chemistry-including electrode (i.e., cathode active material), the electrode having the conversion chemistry, intercalation chemistry, or combination conversion/intercalation chemistry material is referred to as the positive electrode. In some common usages, cathode is used in place of positive electrode, and anode is used in place of negative electrode. When a Li-secondary battery is charged, Li ions move from the positive electrode (e.g., NiFₓ, NMC, NCA) towards the negative electrode (e.g., Li-metal). When a Li-secondary battery is discharged, Li ions move towards the positive electrode and from the negative electrode.

Unless explicitly specified to the contrary, a separator as used herein is stable when in contact with lithium metal.

As used herein, the phrase “lithium-stuffed garnet” refers to oxides that are characterized by a crystal structure related to a garnet crystal structure. Lithium-stuffed garnets include compounds having the formula Li_{A}La_{B}Zr_{C}O_{F}, Li_{A}La_{B}M′_{C}M″_{D}Ta_{E}O_{F}, or Li_{A}La_{B}M′_{C}M″_{D}Nb_{E}O_{F}, wherein 4<A<8.5, 1.5<B<4, 0<C≤2, 0<D<2; 0<E<2.5, 10<F<13, and M′ and M″ are each, independently in each instance selected from Al, Mo, W, Nb, Ga, Sb, Ca, Ba, Sr, Ce, Hf, Rb, and Ta; or LiₐLa_{b}Zr_{c}Al_{d}Mₑ″O_{f}, wherein 5<a<7.7; 2<b<4; 0<c≤2.5; 0<d<2; 0<e<2, 10<f<13 and Me″ is a metal selected from Nb, V, W, Mo, Ta, Ga, and Sb. Garnets, as used herein, also include those garnets described above that are doped with Al or Al₂O₃. Also, garnets as used herein include, but are not limited to, Li_{A}La_{B}Zr_{C}O_{F}+yAl₂O₃, wherein x may be from 5.8 to 7.0, and y may be 0.1, 0.2, 0.3, 0.4, 0.5, 0.6, 0.7, 0.8, 0.9, or 1.0; and wherein 4<A<8.5, 1.5<B<4, 0<C≤2, 0<D<2; 10<F<13. Also, garnets as used herein include, but are not limited to, LiₓLa₃Zr₂O₁₂+yAl₂O₃, wherein x may be from 5.8 to 7.0, and y may be 0.1, 0.2, 0.3, 0.4, 0.5, 0.6, 0.7, 0.8, 0.9, or 1.0. As used herein, garnet does not include YAG-garnets (i.e., yttrium aluminum garnets, or, e.g., Y₃Al₅O₁₂). As used herein, garnet does not include silicate-based garnets such as pyrope, almandine, spessartine, grossular, hessonite, or cinnamon-stone, tsavorite, uvarovite and andradite and the solid solutions pyrope-almandine-spessarite and uvarovite-grossular-andradite. Garnets herein do not include nesosilicates having the general formula X₃Y₂(SiO₄)₃ wherein X is Ca, Mg, Fe, and, or Mn; and Y is Al, Fe, and, or Cr.

As used herein, the phrase “lithium stuffed garnet” refers to oxides that are characterized by a crystal structure related to a garnet crystal structure. Example lithium-stuffed garnet electrolytes include those electrolytes set forth in US Patent Application Publication No. 2015/0099190, published on Apr. 9, 2015, entitled GARNET MATERIALS FOR LI SECONDARY BATTERIES AND METHODS OF MAKING AND USING GARNET MATERIALS, and filed Oct. 7, 2014, the contents of which are incorporated by reference in their entirety. Li-stuffed garnets generally having a composition according to Li_{A}La_{B}M′_{C}M″_{D}Zr_{E}O_{F},
Li_{A}La_{B}M′_{C}M″_{D}Ta_{E}O_{F}, or
Li_{A}La_{B}M′_{C}M″_{D}Nb_{E}O_{F}, wherein 4<A<8.5, 1.5<B<4, 0≤C≤2.5, 0≤D≤2.5; 0≤E<2.3, 10<F<13, and M′ and M″ are each, independently in each instance selected from Al, Mo, W, Ga, Gd, Y, Nb, Sb, Ca, Ba, Sr, Ce, Hf, Rb, or Ta, or LiₐLa_{b}Zr_{c}Al_{d}Me″ₑO_{f}, wherein 5<a<8.5; 2<b<4; 0<c≤2.5; 0≤d≤2; 0≤e<2, and 10<f<13 and Me″ is a metal selected from Nb, Ta, V, W, Mo, or Sb and as otherwise described in U.S. Patent Application Publication No. U.S. 2015/0099190. In some embodiments, A may be about 6.0 or about 6.1 or about 6.2 or about 6.3 or about 6.4 or about 6.5 or about 6.6 or about 6.7 or about 6.8 or about 6.9 or about 7.0 or about 7.1 or about 7.2 or about 7.3 or about 7.4. In some embodiments, B may be about 2.8 or about 2.9 or about 3.0 or about 3.1 or about 3.2. In some embodiments, C may be about 0 or about 0.1 or about 0.2 or about 0.3 or about 0.4 or about 0.5 or about 0.6 or about 0.7 or about 0.8 or about 0.9 or about 1.0 or about 1.1 or about 1.2 or about 1.3 or about 1.4 or about 1.5 or about 1.6 or about 1.7 or about 1.8 or about 1.9 or about 2.0. In some embodiments D may be about 0 or about 0.1 or about 0.2 or about 0.3 or about 0.4 or about 0.5 or about 0.6 or about 0.7 or about 0.8 or about 0.9 or about 1.0 or about 1.1 or about 1.2 or about 1.3 or about 1.4 or about 1.5 or about 1.6 or about 1.7 or about 1.8 or about 1.9 or about 2.0. In some embodiments, E may be about 1.4 or about 1.5 or about 1.6 or about 1.7 or about 1.8 or about 1.9 or about 2.0 or about 2.1 or about 2.2. In some embodiments, F may be about 11.0 or about 11.1 or about 11.2 or about 11.3 or about 11.4 or about 11.5 or about 11.6 or about 11.7 or about 11.8 or about 11.9 or about 12.0 or about 12.1 or about 12.2 or about 12.3 or about 12.4 or about 12.5 or about 12.6 or about 12.7 or about 12.8 or about 12.9 or about 13.0. Herein, the subscript values and coefficient values are selected so the compound is charge neutral unless stated otherwise to the contrary. As used herein, lithium-stuffed garnets, and garnets, generally, include, but are not limited to, Li_{7.0}La₃(Zrₜ₁+Nbₜ₂+Taₜ₃) O₁₂+0.35Al₂O₃; wherein (subscripts t1+t2+t3=subscript 2) so that the La:(Zr/Nb/Ta) ratio is 3:2. Also, garnets used herein include, but are not limited to, LiₓLa₃Zr₂O_{F}+yAl₂O₃, wherein x ranges from 5.5 to 9; and y ranges from 0 to 1. In these embodiments, subscripts x, y, and F are selected so that the garnet is charge neutral. In some embodiments x is 7 and y is 1.0. In some embodiments, x is 5 and y is 1.0. In some embodiments, x is 6 and y is 1.0. In some embodiments, x is 8 and y is 1.0. In some embodiments, x is 9 and y is 1.0. In some embodiments x is 7 and y is 0.35. In some embodiments, x is 5 and y is 0.35. In some embodiments, x is 6 and y is 0.35. In some embodiments, x is 8 and y is 0.35. In some embodiments, x is 9 and y is 0.35. In some embodiments x is 7 and y is 0.7. In some embodiments, x is 5 and y is 0.7. In some embodiments, x is 6 and y is 0.7. In some embodiments, x is 8 and y is 0.7. In some embodiments, x is 9 and y is 0.7. In some embodiments x is 7 and y is 0.75. In some embodiments, x is 5 and y is 0.75. In some embodiments, x is 6 and y is 0.75. In some embodiments, x is 8 and y is 0.75. In some embodiments, x is 9 and y is 0.75. In some embodiments x is 7 and y is 0.8. In some embodiments, x is 5 and y is 0.8. In some embodiments, x is 6 and y is 0.8. In some embodiments, x is 8 and y is 0.8. In some embodiments, x is 9 and y is 0.8. In some embodiments x is 7 and y is 0.5. In some embodiments, x is 5 and y is 0.5. In some embodiments, x is 6 and y is 0.5. In some embodiments, x is 8 and y is 0.5. In some embodiments, x is 9 and y is 0.5. In some embodiments x is 7 and y is 0.4. In some embodiments, x is 5 and y is 0.4. In some embodiments, x is 6 and y is 0.4. In some embodiments, x is 8 and y is 0.4. In some embodiments, x is 9 and y is 0.4. In some embodiments x is 7 and y is 0.3. In some embodiments, x is 5 and y is 0.3. In some embodiments, x is 6 and y is 0.3. In some embodiments, x is 8 and y is 0.3. In some embodiments, x is 9 and y is 0.3. In some embodiments x is 7 and y is 0.22. In some embodiments, x is 5 and y is 0.22. In some embodiments, x is 6 and y is 0.22. In some embodiments, x is 8 and y is 0.22. In some embodiments, x is 9 and y is 0.22. Also, garnets as used herein include, but are not limited to, LiₓLa₃Zr₂O₁₂+yAl₂O₃. In one embodiment, the Li-stuffed garnet herein has a composition of Li₇Li₃Zr₂O₁₂. In another embodiment, the Li-stuffed garnet herein has a composition of Li₇Li₃Zr₂O₁₂·Al₂O₃. In yet another embodiment, the Li-stuffed garnet herein has a composition of
Li₇Li₃Zr₂O₁₂·0.22Al₂O₃. In yet another embodiment, the Li-stuffed garnet herein has a composition of Li₇Li₃Zr₂O₁₂·0.35Al₂O₃. In certain other embodiments, the Li-stuffed garnet herein has a composition of Li₇Li₃Zr₂O₁₂·0.5Al₂O₃. In another embodiment, the Li-stuffed garnet herein has a composition of
Li₇Li₃Zr₂O₁₂·0.75Al₂O₃.

As used herein, lithium-stuffed garnet and/or garnet does not include YAG-garnets (i.e., yttrium aluminum garnets, or, e.g., Y₃Al₅O₁₂). As used herein, garnet does not include silicate-based garnets such as pyrope,
almandine, spessartine, grossular, hessonite, or cinnamon-stone,
tsavorite, uvarovite and andradite and the solid solutions pyrope-almandine-spessarite and uvarovite-grossular-andradite. Garnets herein do not include nesosilicates having the general formula X₃Y₂(SiO₄)₃ wherein X is Ca, Mg, Fe, and, or, Mn; and Y is Al, Fe, and, or, Cr.

As used herein, the phrases “garnet precursor chemicals,” “chemical precursor to a garnet-type electrolyte,” “precursors to garnet” and “garnet precursor materials” refer to chemicals which react to form a lithium stuffed garnet material described herein. These chemical precursors include, but are not limited to lithium hydroxide (e.g., LiOH), lithium oxide (e.g., Li₂O), lithium carbonate (e.g., LiCO₃), zirconium oxide (e.g., ZrO₂), zirconium hydroxide, zirconium acetate, zirconium nitrate, zirconium acetylacetonate, zirconium nitrate x-hydrate, lanthanum oxide (e.g., La₂O₃), lanthanum hydroxide (e.g., La(OH)₃), lanthanum nitrate, lanthanum acetate, lanthanum acetylacetonate, aluminum oxide (e.g., Al₂O₃), aluminum hydroxide (e.g., Al(OH)₃), aluminum (e.g., Al), aluminum nitrate (e.g., Al(NO₃)₃), aluminum nitrate nonahydrate, boehmite, gibbsite, corundum, aluminum oxyhydroxide, niobium oxide (e.g., Nb₂O₅), gallium oxide (Ga₂O₃), and tantalum oxide (e.g., Ta₂O₅). Other precursors to garnet materials may be suitable for use with the methods set forth herein.

As used herein the phrase “garnet-type electrolyte,” refers to an electrolyte that includes a lithium stuffed garnet material described herein as the Li⁺ ion conductor.

As used herein, the phrase “doped with alumina” means that Al₂O₃ is used to replace certain components of another material, e.g., a garnet. A lithium stuffed garnet that is doped with Al₂O₃ refers to garnet wherein aluminum (Al) substitutes for an element in the lithium stuffed garnet chemical formula, which may be, for example, Li or Zr.

As used herein, area-specific resistance (ASR) is measured by electrochemical cycling using an Arbin or Biologic instrument unless otherwise specified to the contrary.

As used herein, “flatness” of a surface refers to the greatest normal distance between the lowest point on a surface and a plane containing the three highest points on the surface, or alternately, the greatest normal distance between the highest point on a surface and a plane containing the three lowest points on the surface. It may be measured with an AFM, a high precision optical microscope, or laser interferometry height mapping of a surface.

As used herein, “porosity” of a body is the fractional volume that is not occupied by material. It may be measured by mercury porosimetry or by cross-sectioning the body and optically determining the 2D fractional area of porosity of the cross-sectioned surface.

As used herein, a green body is a material which is deposited from a slurry and which includes ceramics, or ceramic precursors, and at least one member selected from a solvent, a binder, a dispersant, a plasticizer, a surfactant, or a combination thereof. A green body is considered green before it is heated to either, or both, remove organic material such as the solvent, binder, dispersant, plasticizer, surfactant, or a combination thereof; or sinter the ceramic component of the green body. A green body is made by depositing a slurry onto a substrate and optionally allowing the deposited slurry to dry.

As used herein, the phrase “green film” or “green tape” refers to an unsintered tape or film that includes lithium-stuffed garnet, precursors to lithium-stuffed garnet, or a combination thereof and at least one of a binder, plasticizer, carbon, dispersant, solvent, or combinations thereof. As used herein, “green film tape” refers to a roll, continuous layer, or cut portion thereof of casted tape, either dry or not dry, of green film. The phrase “green body” is used interchangeably herein with the phrases “green film” or “green tape.” A green tape may also include the patches of green bodies which are deposited on a metal layer (i.e., patch coating of a metal layer).

As used herein, a “sintered bilayer” refers to a two-layer structure comprising a sintered solid-state electrolyte and a metal foil. As used herein, a “green bilayer” refers to a two-layer structure comprising a green film and a metal foil. In some examples, the metal foil is a metal layer.

As used herein, area-specific resistance (ASR) is measured by electrochemical cycling using an Arbin or Biologic instrument unless otherwise specified to the contrary. The ASR is calculated by measuring a voltage drop ΔV after 30-180s in response to a current interrupt measurement ASR=ΔV/J, where J is the current density in A/cm2.

As used herein, ionic conductivity is measured by electrical impedance spectroscopy methods known in the art.

As used herein the phrase “casting a film,” refers to the process of delivering or transferring a liquid or a slurry into a mold, or onto a substrate, such that the liquid or the slurry forms, or is formed into, a film. Casting may be done via doctor blade, meyer rod, comma coater, gravure coater, microgravure, reverse comma coater, slot die, slip and/or tape casting, and other methods.

### EMBODIMENTS

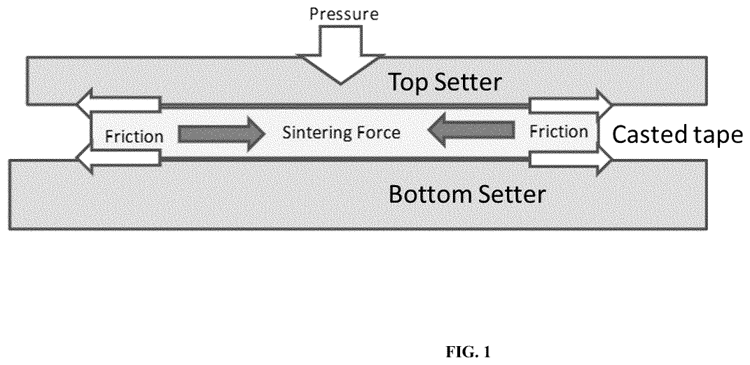

FIG. 1 illustrates a conventional setter stack. FIG. 1 illustrates a top setter and a bottom setter. In between the top and bottom setter is a casted tape. As indicated by the arrows, the top setter applies a downward force due to gravity. This force manifests as a pressure across the area of the casted tape. As the casted tape is heated and eventually sintered, the casted tape shrinks in size. In the direction parallel to the top and bottom setters, the casted tape will shrink laterally and across the surfaces of the top and bottom setters. If there is friction between the sintering casted tape and the surface of the top setter, the bottom setter, or both, then there will be adhesive forces due to friction present as well. This is illustrated in FIG. 1. The casted tape will also shrink in the direction perpendicular to the surface of the top setter or of the bottom setter.

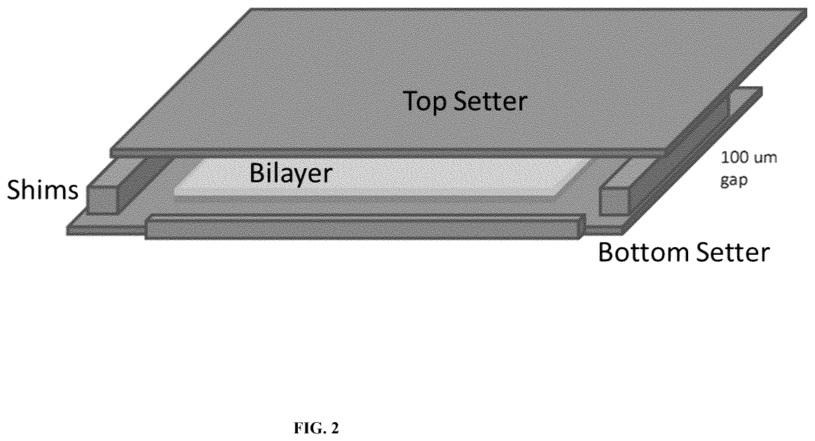

FIG. 2 illustrates a setter stack in accordance with an embodiment herein. FIG. 2 illustrates a top setter and a bottom setter. In between the top and bottom setter is a bilayer that includes one layer comprising a metal and a second layer comprising a green film or a sintered film. In some embodiments, the sintered film is a lithium-stuffed garnet sintered film. In some embodiments, including any of the foregoing, the layer comprising a metal further comprises lithium-stuffed garnet. In some embodiments, including any of the foregoing, the layer comprising a metal comprises Nickel (Ni). In some embodiments, including any of the foregoing, the layer comprising a metal comprises Copper (Cu). In some embodiments, including any of the foregoing, the layer comprising a metal comprises iron (Fe). FIG. 2 shows shims which separate the top setter from the bottom setter. The shims, in some embodiments are taller than the thickness of the bilayer. In some other embodiments, the shim is the same height as the thickness of the bilayer. The shims, in some embodiments are shorter than the thickness of the bilayer. The shims, in some embodiments are shorter than the thickness of the bilayer before sintering the bilayer but are taller than the thickness of the bilayer after sintering.

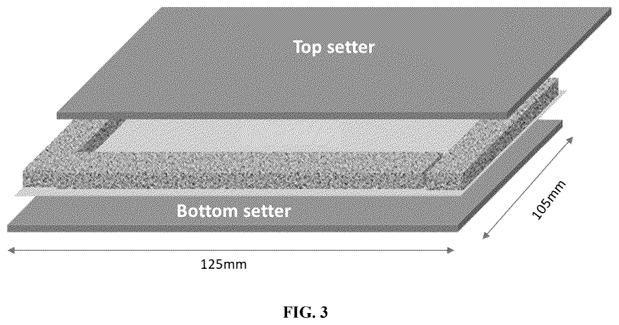

FIG. 3 illustrates a setter stack in accordance with an embodiment herein. FIG. 3 illustrates a top setter and a bottom setter. In between the top and bottom setter is a bilayer that includes one layer comprising a metal and a second layer comprising a green film or a sintered film. In some embodiments, the sintered film is a lithium-stuffed garnet sintered film. In some embodiments, including any of the foregoing, the layer comprising a metal further comprises lithium-stuffed garnet. In some embodiments, including any of the foregoing, the layer comprising a metal comprises Nickel (Ni). In some embodiments, including any of the foregoing, the layer comprising a metal comprises Copper (Cu). In some embodiments, including any of the foregoing, the layer comprising a metal comprises iron (Fe). FIG. 3 shows shims which separate the top setter from the bottom setter. The shims, in some examples are taller than the thickness of the bilayer. In some other embodiments, the shim is the same height as the thickness of the bilayer. In some other embodiments, the shim is a foam cut-out. In some embodiments, the top setter and the shims form a single piece top setter.

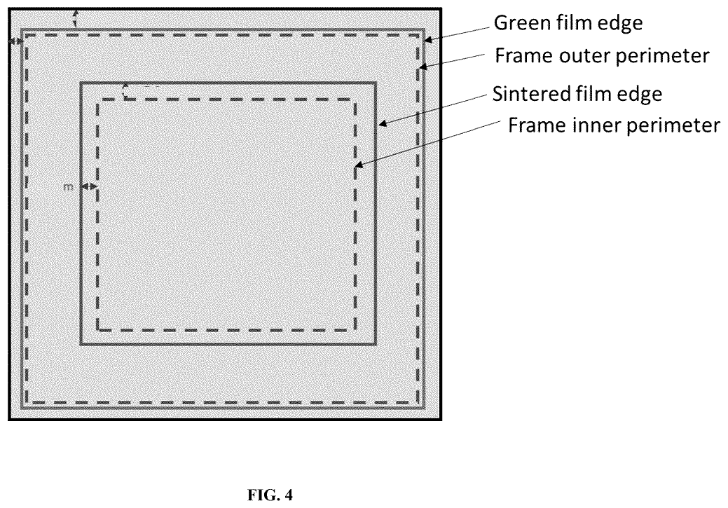

FIG. 4 shows a top-down view a top setter having a perimeter but not having a center. In FIG. 4, the top setter is referred to as a frame. FIG. 4 shows the outline of a green film that would sit on a 136 mm×115 mm setter. The green film would have dimensions of approximately 121.8 mm×98.0 mm. After sintering, the green film would transform into a sintered film and would shrink in size. FIG. 4 shows the outline of a sintered film that would sit on the setter and have dimension of about 96.8 mm×77.9 mm. The top setter (i.e., frame) would have dimensions such that the frame, or a portion of it, cover both the green film, or the green film perimeter, before sintering and also the sintered film after sintering, or the sintered film's perimeter, and as shown in FIG. 4. In one embodiment, the frame would have an outer perimeter dimension of 121.8 mm×98.0 mm. In one embodiment, the frame would have an inner perimeter dimension of 86.8 mm×67.9 mm. In FIG. 4, the frame has 7.1 mm margin on one side, and an 8.5 mm margin on another side, between the frame and the edge of the setter on which the frame sits. Other dimensions other than those in FIG. 4 are possible so long as the frame extends to the edge of the green film before sintering and does not expose the edge of the sintered film after sintering.

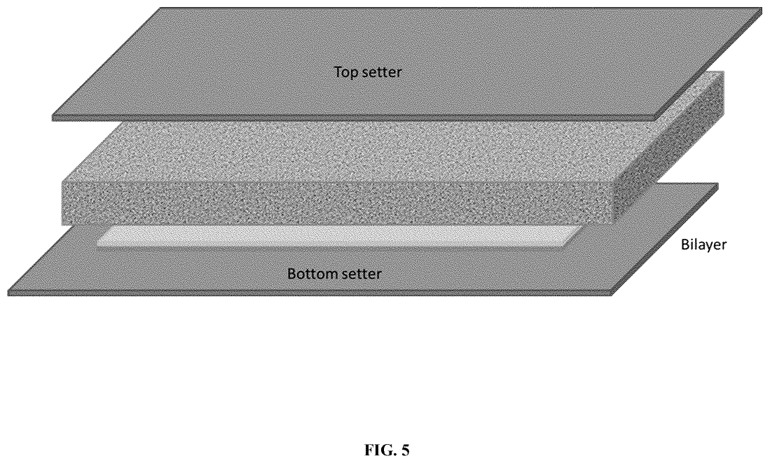

FIG. 5 shows an embodiment in which a bilayer is sandwiched between a foam material and a bottom setter. On top of the foam material is a top setter, which may optionally be present or not present. In some embodiments, including any of the foregoing, the bilayer includes one layer comprising a metal and a second layer comprising a green film or a sintered film. In some embodiments, the sintered film is a lithium-stuffed garnet sintered film. In some embodiments, including any of the foregoing, the layer comprising a metal further comprises lithium-stuffed garnet. In some embodiments, including any of the foregoing, the layer comprising a metal comprises Nickel (Ni). In some embodiments, including any of the foregoing, the layer comprising a metal comprises Copper (Cu). In some embodiments, including any of the foregoing, the layer comprising a metal comprises iron (Fe). In some embodiments, including any of the foregoing, the foam material is a metal foam. In some embodiments, including any of the foregoing, the foam material is a porous nickel foam.

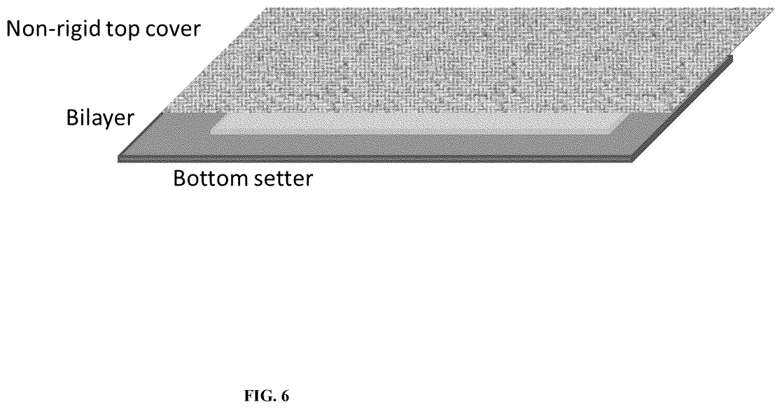

FIG. 6 shows an embodiment in which a bilayer is sandwiched between a non-rigid top cover and a bottom setter. In some embodiments, the top cover is a top setter. In some embodiments, the top cover is a foam material. In some embodiments, including any of the foregoing, the bilayer includes one layer comprising a metal and a second layer comprising a green film or a sintered film. In some embodiments, the sintered film is a lithium-stuffed garnet sintered film. In some embodiments, including any of the foregoing, the layer comprising a metal further comprises lithium-stuffed garnet. In some embodiments, including any of the foregoing, the layer comprising a metal comprises Nickel (Ni). In some embodiments, including any of the foregoing, the layer comprising a metal comprises Copper (Cu). In some embodiments, including any of the foregoing, the layer comprising a metal comprises iron (Fe). In some embodiments, including any of the foregoing, the foam material is a metal foam. In some embodiments, including any of the foregoing, the foam material is a porous nickel foam.

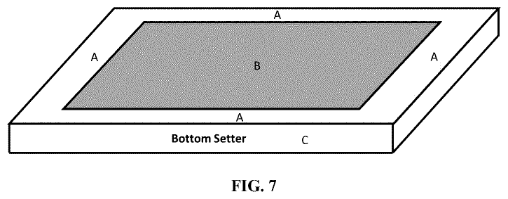

FIG. 7 shows an embodiment in which a bilayer (B) is sandwiched between a center-less cover (A) and a bottom setter (C). In some embodiments, the center-less cover (A) is a top setter. In some embodiments, the center-less cover (A) is a foam material. In some embodiments, including any of the foregoing, the bilayer (B) includes one layer comprising a metal and a second layer comprising a green film or a sintered film. In some embodiments, the sintered film of the bilayer (B) is a lithium-stuffed garnet sintered film. In some embodiments, including any of the foregoing, the layer comprising a metal of the bilayer (B) further comprises lithium-stuffed garnet. In some embodiments, including any of the foregoing, the layer comprising a metal of the bilayer (B) comprises Nickel (Ni). In some embodiments, including any of the foregoing, the layer comprising a metal comprises Copper (Cu). In some embodiments, including any of the foregoing, the layer comprising a metal comprises iron (Fe). In some embodiments, including any of the foregoing, the foam material is a metal foam. In some embodiments, including any of the foregoing, the foam material is a porous nickel foam.

### Stacks

In an embodiment, set forth herein is a stack including: a bottom setter including at least one or more refractory materials; a bilayer disposed on the bottom setter, wherein the bilayer includes: a layer including an oxide, and a layer including a metal; a top setter disposed on the bilayer, wherein the top setter has a perimeter but does not have a center.

In some embodiments, including any of the foregoing, the layer including an oxide does not include a metal in the layer including an oxide.

In some embodiments, including any of the foregoing, the layer including an oxide consists of an oxide.

In some embodiments, including any of the foregoing, the layer including an oxide consists essentially of an oxide.

In some embodiments, including any of the foregoing, the layer including an oxide includes a lithium-stuffed garnet oxide.

In some embodiments, including any of the foregoing, the layer including an oxide further includes metal in the layer including an oxide.

In some embodiments, including any of the foregoing, the metal in the layer including an oxide is selected from the group consisting of nickel (Ni), iron (Fe), copper (Cu), titanium (Ti), zirconium (Zr), and combinations thereof.

In some embodiments, including any of the foregoing, the metal in the layer including an oxide is Ni.

In some embodiments, including any of the foregoing, the metal in the layer including an oxide is Fe.

In some embodiments, including any of the foregoing, the layer including an oxides includes more than one type of metal in the layer including an oxide.

In some embodiments, including any of the foregoing, the layer including a metal includes a metal selected from the group consisting of nickel (Ni), iron (Fe), copper (Cu), titanium (Ti), zirconium (Zr), and combinations thereof.

In some embodiments, including any of the foregoing, the layer including a metal includes Ni.

In some embodiments, including any of the foregoing, the layer including a metal includes Fe.

In some embodiments, including any of the foregoing, the layer including a metal includes Cu.

In some embodiments, including any of the foregoing, the top setter is a metallic foam.

In some embodiments, including any of the foregoing, the top setter is a nickel (Ni) foam.

In some embodiments, including any of the foregoing, the refractory materials are, individually, selected from the group consisting of Al₂O₃, LiAlO₂, Li₇La₃Zr₂O₁₂, Li₂ZrO₃, xLi₂O-(1-x)SiO₂ (where x=0.01-0.99), aLi₂O-bB₂O₃-cSiO₂ (where a+b+c=1), LiLaO₂, Li₂O, Li₃PO₄, ZrO₂, ZnO₂, and combinations thereof.

In some embodiments, including any of the foregoing, the top setter includes a refractory materials selected from the group consisting of Al₂O₃, LiAlO₂, Li₇La₃Zr₂O₁₂, Li₂ZrO₃, xLi₂O-(1-x)SiO₂ (where x=0.01-0.99), aLi₂O-bB₂O₃-cSiO₂ (where a+b+c=1), LiLaO₂, Li₂O, Li₃PO₄, ZrO₂, ZnO₂, and combinations thereof.

In some embodiments, including any of the foregoing, the refractory materials include LiAlO₂.

In some embodiments, including any of the foregoing, the stack includes at least one or more shims disposed between the top setter and the bottom setter.

In some embodiments, including any of the foregoing, the stack includes a third setter including at least one or more refractory materials disposed above the top setter.

In some embodiments, including any of the foregoing, the stack further includes a layer including a shim disposed above the top setter and between the top setter and the third setter including at least one or more refractory materials disposed above the top setter.

In some embodiments, including any of the foregoing, the two or more stacks are stacked on top of each other.

In an embodiment, set forth herein is a stack including: a bottom setter; a bilayer disposed on the bottom setter, wherein the bilayer includes: a layer including an oxide, and a layer including a metal; a metallic mesh disposed on the electrolyte bilayer.

In some embodiments, including any of the foregoing, the metal mesh includes Ni.

In some embodiments, including any of the foregoing, the metal mesh is a metallic foam.

In some embodiments, including any of the foregoing, the layer including an oxide does not include a metal in the layer including an oxide.

In some embodiments, including any of the foregoing, the layer including an oxide consists of an oxide.

In some embodiments, including any of the foregoing, the layer including an oxide consists essentially of an oxide.

In some embodiments, including any of the foregoing, the layer including an oxide includes a lithium-stuffed garnet oxide.

In some embodiments, including any of the foregoing, the layer including an oxide further includes metal in the layer including an oxide.

In some embodiments, including any of the foregoing, the metal in the layer including an oxide is selected from the group consisting of nickel (Ni), iron (Fe), copper (Cu), titanium (Ti), zirconium (Zr), and combinations thereof.

In some embodiments, including any of the foregoing, the metal in the layer including an oxide is Ni.

In some embodiments, including any of the foregoing, the metal in the layer including an oxide is Fe.

In some embodiments, including any of the foregoing, the stack includes more than one type of metal in the layer including an oxide.

In some embodiments, including any of the foregoing, the layer including a metal includes a metal selected from the group consisting of nickel (Ni), iron (Fe), copper (Cu), titanium (Ti), zirconium (Zr), and combinations thereof.

In some embodiments, including any of the foregoing, the layer including a metal includes Ni.

In some embodiments, including any of the foregoing, the layer including a metal includes Fe.

In some embodiments, including any of the foregoing, the layer including a metal includes Cu.

In some embodiments, including any of the foregoing, the bottom setter includes one or more refractory materials, wherein the refractory materials are selected from the group consisting of Al₂O₃, LiAlO₂, Li₇La₃Zr₂O₁₂, Li₂ZrO₃, xLi₂O-(1-x)SiO₂ (where x=0.01-0.99), aLi₂O-bB₂O₃-cSiO₂ (where a+b+c=1), LiLaO₂, Li₂O, Li₃PO₄, ZrO₂, ZnO₂, and combinations thereof.

In some embodiments, including any of the foregoing, the top setter includes a refractory materials selected from Al₂O₃, LiAlO₂, Li₇La₃Zr₂O₁₂, Li₂ZrO₃, xLi₂O-(1-x)SiO₂ (where x=0.01-0.99), aLi₂O-bB₂O₃-cSiO₂ (where a+b+c=1), LiLaO₂, Li₂O, Li₃PO₄, ZrO₂, ZnO₂, or combinations thereof.

In some embodiments, including any of the foregoing, the refractory material includes LiAlO₂.

In some embodiments, including any of the foregoing, the stack includes at least one or more shims disposed between the metallic mesh and the bottom setter.

In some embodiments, including any of the foregoing, the metallic mesh contacts the bilayer.

In some embodiments, including any of the foregoing, the stack includes a setter including at least one or more refractory materials disposed above the metallic mesh.

In some embodiments, including any of the foregoing, the stack includes a layer including a shim disposed above the metallic mesh and between the metallic mesh and the setter including at least one or more refractory materials disposed above the metallic mesh.

In some embodiments, including any of the foregoing, the two or more stacks are stacked on top of each other.

In an embodiment, set forth herein is a stack including: a bottom setter; a bilayer disposed on the bottom setter, wherein the bilayer includes: a layer including an oxide, and a layer including a metal; at least one or more shims including a refractory material disposed above the bilayer.

In an embodiment, set forth herein is a stack including: a bottom setter; a bilayer disposed on the bottom setter, wherein the bilayer includes: a layer including an oxide, and a layer including a metal; at least one or more shims including a refractory material disposed around the bilayer.

In some embodiments, including any of the foregoing, the layer including an oxide does not include a metal in the layer including an oxide.

In some embodiments, including any of the foregoing, the layer including an oxide consists of an oxide.

In some embodiments, including any of the foregoing, the layer including an oxide consists essentially of an oxide.

In some embodiments, including any of the foregoing, the layer including an oxide includes a lithium-stuffed garnet oxide.

In some embodiments, including any of the foregoing, the layer including an oxide further includes metal in the layer including an oxide.

In some embodiments, including any of the foregoing, the metal in the layer including an oxide is selected from the group consisting of nickel (Ni), iron (Fe), copper (Cu), titanium (Ti), zirconium (Zr), and combinations thereof.

In some embodiments, including any of the foregoing, the metal in the layer including an oxide is Ni.

In some embodiments, including any of the foregoing, the metal in the layer including an oxide is Fe.

In some embodiments, including any of the foregoing, including more than one type of metal in the layer including an oxide.

In some embodiments, including any of the foregoing, the layer including a metal includes a metal selected from the group consisting of nickel (Ni), iron (Fe), copper (Cu), titanium (Ti), zirconium (Zr), and combinations thereof.

In some embodiments, including any of the foregoing, the layer including a metal includes Ni.

In some embodiments, including any of the foregoing, the layer including a metal includes Fe.

In some embodiments, including any of the foregoing, the layer including a metal includes Cu.

further including a top setter disposed on top of the at least one or more shims including a refractory material.

In some embodiments, including any of the foregoing, the top setter is a metallic foam.

In some embodiments, including any of the foregoing, the top setter is a nickel (Ni) foam.

In some embodiments, including any of the foregoing, the refractory materials are selected from Al₂O₃, LiAlO₂, Li₇La₃Zr₂O₁₂, Li₂ZrO₃, xLi₂O-(1-x)SiO₂ (where x=0.01-0.99), aLi₂O-bB₂O₃-cSiO₂ (where a+b+c=1), LiLaO₂, Li₂O, Li₃PO₄, ZrO₂, ZnO₂, or combinations thereof.

In some embodiments, including any of the foregoing, the top setter includes a refractory materials selected from Al₂O₃, LiAlO₂, Li₇La₃Zr₂O₁₂, Li₂ZrO₃, xLi₂O-(1-x)SiO₂ (where x=0.01-0.99), aLi₂O-bB₂O₃-cSiO₂ (where a+b+c=1), LiLaO₂, Li₂O, Li₃PO₄, ZrO₂, ZnO₂, or combinations thereof.

In some embodiments, including any of the foregoing, the refractory material includes LiAlO₂.

In some embodiments, including any of the foregoing, the stack includes a third setter including at least one or more refractory materials disposed above the top setter.

In some embodiments, including any of the foregoing, the stack further includes a layer including a shim disposed above the top setter and between the top setter and an additional layer including at least one or more refractory materials disposed above the top setter.

In some embodiments, including any of the foregoing, the two or more stacks are stacked on top of each other.

In some embodiments, including any of the foregoing, the bilayer is oriented so that the layer including an oxide contacts the bottom setter.

In some embodiments, including any of the foregoing, the bilayer is oriented so that the layer including a metal contacts the bottom setter.

In some embodiments, including any of the foregoing, the bilayer herein includes a green body deposited onto a metal layer. In some examples, the green body is continuous and in other examples the green body is deposited in a patch coating format. After sintering, a bilayer may have a ceramic layer thickness of 10 μm-40 μm and the metal layer thickness is 2 μm-20 μm thick. The bilayer may have a ceramic layer thickness of 20 μm-30 μm and the metal layer thickness is 3 μm-10 μm thick.

In some examples, including any of the foregoing, the metal layer of the bilayer comprises a metal selected from the group consisting of nickel (Ni), iron (Fe), copper (Cu), platinum (Pt), gold (Au), silver), an alloy thereof, or a combination thereof.

In some examples, including any of the foregoing, the metal layer of the bilayer is an alloy of Fe and Ni.

In some examples, including any of the foregoing, the metal layer of the bilayer is an alloy of Fe and Ni, and the amount of Fe is 1% to 25% (w/w) with the remainder being Ni.

In some examples, including any of the foregoing, the thickness of the metal layer of the bilayer is 1 μm to 20 μm.

In some examples, including any of the foregoing, the thickness of the metal layer of the bilayer is 1 μm to 10 μm.

In some examples, including any of the foregoing, the thickness of the metal layer of the bilayer is 5 μm to 10 μm.

In some examples, including any of the foregoing, the sintered bilayer comprises sintered lithium-stuffed garnet.

In some examples, including any of the foregoing, the green body comprises a binder.

In some examples, including any of the foregoing, the green body comprises a dispersant.

In some examples, including any of the foregoing, the green body comprises a solvent or a combination of solvents.

In some examples, a bilayer after sintering may have a width of 1 In some examples, a bilayer after sintering may have a width of 1 cm to 25 cm. In some examples, a bilayer after sintering may have a width of 2 cm to 22 cm. In some examples, a bilayer after sintering may have a width of 4 cm to 22 cm. In some examples, a bilayer after sintering may have a width of 6 cm to 22 cm. In some examples, a bilayer after sintering may have a width of 8 cm to 22 cm. In some examples, a bilayer after sintering may have a width of 10 cm to 22 cm. In some examples, a bilayer after sintering may have a width of 12 cm to 22 cm. In some examples, a bilayer after sintering may have a width of 14 cm to 22 cm. In some examples, a bilayer after sintering may have a width of 16 cm to 22 cm.

In some examples, a sintered film may have a width of 2 cm to 25 cm. In some examples, a sintered film may have a width of 4 cm to 25 cm. In some examples, a sintered film may have a width of 6 cm to 25 cm. In some examples, a sintered film may have a width of 8 cm to 25 cm. In some examples, a sintered film may have a width of 10 cm to 25 cm. In some examples, a sintered film may have a width of 12 cm to 25 cm. In some examples, a sintered film may have a width of 14 cm to 25 cm. In some examples, a sintered film may have a width of 16 cm to 25 cm.

In some examples, a bilayer after sintering may have a width of 2 cm to 25 cm. In some examples, a bilayer after sintering may have a width of 4 cm to 25 cm. In some examples, a bilayer after sintering may have a width of 6 cm to 25 cm. In some examples, a bilayer after sintering may have a width of 8 cm to 25 cm. In some examples, a bilayer after sintering may have a width of 10 cm to 25 cm. In some examples, a bilayer after sintering may have a width of 12 cm to 25 cm. In some examples, a bilayer after sintering may have a width of 14 cm to 25 cm. In some examples, a bilayer after sintering may have a width of 16 cm to 25 cm.

In some examples, a sintered film may have a width of 1 cm. In some examples, a sintered film may have a width of 2 cm. In some examples, a sintered film may have a width of 1 cm. In some examples, a sintered film may have a width of 3 cm. In some examples, a sintered film may have a width of 4 cm. In some examples, a sintered film may have a width of 5 cm. In some examples, a sintered film may have a width of 6 cm. In some examples, a sintered film may have a width of 7 cm. In some examples, a sintered film may have a width of 8 cm. In some examples, a sintered film may have a width of 9 cm. In some examples, a sintered film may have a width of 10 cm. In some examples, a sintered film may have a width of 11 cm. In some examples, a sintered film may have a width of 12 cm. In some examples, a sintered film may have a width of 13 cm. In some examples, a sintered film may have a width of 14 cm. In some examples, a sintered film may have a width of 15 cm. In some examples, a sintered film may have a width of 16 cm. In some examples, a sintered film may have a width of 17 cm. In some examples, a sintered film may have a width of 18 cm. In some examples, a sintered film may have a width of 19 cm. In some examples, a sintered film may have a width of 20 cm. In some examples, a sintered film may have a width of 21 cm. In some examples, a sintered film may have a width of 22 cm. In some examples, a sintered film may have a width of 23 cm. In some examples, a sintered film may have a width of 24 cm. In some examples, a sintered film may have a width of 25 cm.

Herein, in some examples, the sintered film, or bilayer after sintering, has a thickness less than 200 μm. In some examples, including any of the foregoing, the sintered film, or bilayer after sintering, has a thickness less than 100 μm. In some examples, including any of the foregoing, the sintered film, or bilayer after sintering, has a thickness less than 60 μm. In some examples, including any of the foregoing, the sintered film, or bilayer after sintering, has a thickness less than 50 μm. In some examples, including any of the foregoing, the sintered film, or bilayer after sintering, has a thickness less than 40 μm. In some examples, including any of the foregoing, the sintered film, or bilayer after sintering, has a thickness less than 30 μm. In some examples, including any of the foregoing, the sintered film, or bilayer after sintering, has a thickness less than 25 μm. In some examples, including any of the foregoing, the sintered film, or bilayer after sintering, has a thickness less than 20 μm. In some examples, including any of the foregoing, the sintered film, or bilayer after sintering, has a thickness less than 15 μm. In some examples, including any of the foregoing, the sintered film, or bilayer after sintering, has a thickness less than 10 μm. In some examples, including any of the foregoing, the sintered film, or bilayer after sintering, has a thickness less than 5 μm. In some examples, including any of the foregoing, the sintered film, or bilayer after sintering, has a thickness between 5 μm and 50 μm. In some examples, including any of the foregoing, the sintered film, or bilayer after sintering, has a thickness between 10 μm and 40 μm. In some examples, including any of the foregoing, the sintered film, or bilayer after sintering, has a thickness between 20 μm and 40 μm. In some examples, including any of the foregoing, the sintered film, or bilayer after sintering, has a thickness of at least 10 μm. In some examples, including any of the foregoing, the sintered film, or bilayer after sintering, has a thickness of at least 20 μm. In some examples, including any of the foregoing, the sintered film, or bilayer after sintering, has a thickness of at least 30 μm. In some examples, including any of the foregoing, the sintered film, or bilayer after sintering, has a thickness of at least 40 μm. In some examples, including any of the foregoing, the sintered film, or bilayer after sintering, has a thickness of at least 50 μm.

Herein, in some examples, the sintered film, or bilayer after sintering, has a thickness of about 200 μm. In some examples, including any of the foregoing, the sintered film, or bilayer after sintering, has a thickness of about 100 μm. In some examples, including any of the foregoing, the sintered film, or bilayer after sintering, has a thickness of about 90 μm. In some examples, including any of the foregoing, the sintered film, or bilayer after sintering, has a thickness of about 80 μm. In some examples, including any of the foregoing, the sintered film, or bilayer after sintering, has a thickness of about 70 μm. In some examples, including any of the foregoing, the sintered film, or bilayer after sintering, has a thickness of about 60 μm. In some examples, including any of the foregoing, the sintered film, or bilayer after sintering, has a thickness of about 50 μm. In some examples, including any of the foregoing, the sintered film, or bilayer after sintering, has a thickness of about 40 μm. In some examples, including any of the foregoing, the sintered film, or bilayer after sintering, has a thickness of about 30 μm. In some examples, including any of the foregoing, the sintered film, or bilayer after sintering, has a thickness of about 25 μm. In some examples, including any of the foregoing, the sintered film, or bilayer after sintering, has a thickness of about 20 μm. In some examples, including any of the foregoing, the sintered film, or bilayer after sintering, has a thickness less than 15 μm. In some examples, including any of the foregoing, the sintered film, or bilayer after sintering, has a thickness of about 10 μm. In some examples, including any of the foregoing, the sintered film, or bilayer after sintering, has a thickness of about 5 μm. In some examples, including any of the foregoing, the sintered film, or bilayer after sintering, has a thickness between 5 μm and 50 μm. In some examples, including any of the foregoing, the sintered film, or bilayer after sintering, has a thickness between 10 μm and 40 μm. In some examples, including any of the foregoing, the sintered film, or bilayer after sintering, has a thickness between 20 μm and 40 μm.

Herein, in some examples, the sintered film, or bilayer after sintering, has a thickness of 200 μm. In some examples, including any of the foregoing, the sintered film, or bilayer after sintering, has a thickness of 100 μm. In some examples, including any of the foregoing, the sintered film, or bilayer after sintering, has a thickness of 90 μm. In some examples, including any of the foregoing, the sintered film, or bilayer after sintering, has a thickness of 80 μm. In some examples, including any of the foregoing, the sintered film, or bilayer after sintering, has a thickness of 70 μm. In some examples, including any of the foregoing, the sintered film, or bilayer after sintering, has a thickness of 60 μm. In some examples, including any of the foregoing, the sintered film, or bilayer after sintering, has a thickness of 50 μm. In some examples, including any of the foregoing, the sintered film, or bilayer after sintering, has a thickness of 45 μm. In some examples, including any of the foregoing, the sintered film, or bilayer after sintering, has a thickness of 40 μm. In some examples, including any of the foregoing, the sintered film, or bilayer after sintering, has a thickness of 35 μm. In some examples, including any of the foregoing, the sintered film, or bilayer after sintering, has a thickness of 30 μm. In some examples, including any of the foregoing, the sintered film, or bilayer after sintering, has a thickness of 25 μm. In some examples, including any of the foregoing, the sintered film, or bilayer after sintering, has a thickness of 20 μm. In some examples, including any of the foregoing, the sintered film, or bilayer after sintering, has a thickness of 18 μm. In some examples, including any of the foregoing, the sintered film, or bilayer after sintering, has a thickness of 16 μm. In some examples, including any of the foregoing, the sintered film, or bilayer after sintering, has a thickness less than 15 μm. In some examples, including any of the foregoing, the sintered film, or bilayer after sintering, has a thickness of 10 μm. In some examples, including any of the foregoing, the sintered film, or bilayer after sintering, has a thickness of 5 μm. In some examples, including any of the foregoing, the sintered film, or bilayer after sintering, has a thickness between 5 μm and 50 μm. In some examples, including any of the foregoing, the sintered film, or bilayer after sintering, has a thickness between 10 μm and 40 μm. In some examples, including any of the foregoing, the sintered film, or bilayer after sintering, has a thickness between 20 μm and 40 μm. In some examples, including any of the foregoing, the sintered film, or bilayer after sintering, has a thickness between 10 μm and 60 μm. In some examples, including any of the foregoing, the sintered film, or bilayer after sintering, has a thickness between 10 μm and 70 μm. In some examples, including any of the foregoing, the sintered film, or bilayer after sintering, has a thickness between 10 μm and 80 μm. In some examples, including any of the foregoing, the sintered film, or bilayer after sintering, has a thickness between 20 μm and 60 μm. In some examples, including any of the foregoing, the sintered film, or bilayer after sintering, has a thickness between 20 μm and 70 μm. In some examples, including any of the foregoing, the sintered film, or bilayer after sintering, has a thickness between 20 μm and 80 μm.

In some of the methods disclosed herein, the thickness of the ceramic film in a bilayer after sintering is from about 10 μm to about 50 μm. In some of the methods disclosed herein, the thickness of the ceramic film in a bilayer after sintering is from about 20 μm to about 40 μm. In some of the methods disclosed herein, the thickness of the ceramic film in a bilayer after sintering is from about 20 μm to about 30 μm.

Herein, in some examples, the sintered film, or bilayer after sintering, has a thickness less than 200 μm. In some examples, including any of the foregoing, the sintered film, or bilayer after sintering, has a thickness less than 100 μm. In some examples, including any of the foregoing, the sintered film, or bilayer after sintering, has a thickness less than 60 μm. In some examples, including any of the foregoing, the sintered film, or bilayer after sintering, has a thickness less than 50 μm. In some examples, including any of the foregoing, the sintered film, or bilayer after sintering, has a thickness less than 40 μm. In some examples, including any of the foregoing, the sintered film, or bilayer after sintering, has a thickness less than 30 μm. In some examples, including any of the foregoing, the sintered film, or bilayer after sintering, has a thickness less than 25 μm. In some examples, including any of the foregoing, the sintered film, or bilayer after sintering, has a thickness less than 20 μm. In some examples, including any of the foregoing, the sintered film, or bilayer after sintering, has a thickness less than 15 μm. In some examples, including any of the foregoing, the sintered film, or bilayer after sintering, has a thickness less than 10 μm. In some examples, including any of the foregoing, the sintered film, or bilayer after sintering, has a thickness less than 5 μm. In some examples, including any of the foregoing, the sintered film, or bilayer after sintering, has a thickness between 5 μm and 50 μm. In some examples, including any of the foregoing, the sintered film, or bilayer after sintering, has a thickness between 10 μm and 40 μm. In some examples, including any of the foregoing, the sintered film, or bilayer after sintering, has a thickness between 20 μm and 40 μm. In some examples, including any of the foregoing, the sintered film, or bilayer after sintering, has a thickness of at least 10 μm. In some examples, including any of the foregoing, the sintered film, or bilayer after sintering, has a thickness of at least 20 μm. In some examples, including any of the foregoing, the sintered film, or bilayer after sintering, has a thickness of at least 30 μm. In some examples, including any of the foregoing, the sintered film, or bilayer after sintering, has a thickness of at least 40 μm. In some examples, including any of the foregoing, the sintered film, or bilayer after sintering, has a thickness of at least 50 μm.

Herein, in some examples, the sintered film, or bilayer after sintering, has a thickness of about 200 μm. In some examples, including any of the foregoing, the sintered film, or bilayer after sintering, has a thickness of about 100 μm. In some examples, including any of the foregoing, the sintered film, or bilayer after sintering, has a thickness of about 90 μm. In some examples, including any of the foregoing, the sintered film, or bilayer after sintering, has a thickness of about 80 μm. In some examples, including any of the foregoing, the sintered film, or bilayer after sintering, has a thickness of about 70 μm. In some examples, including any of the foregoing, the sintered film, or bilayer after sintering, has a thickness of about 60 μm. In some examples, including any of the foregoing, the sintered film, or bilayer after sintering, has a thickness of about 50 μm. In some examples, including any of the foregoing, the sintered film, or bilayer after sintering, has a thickness of about 40 μm. In some examples, including any of the foregoing, the sintered film, or bilayer after sintering, has a thickness of about 30 μm. In some examples, including any of the foregoing, the sintered film, or bilayer after sintering, has a thickness of about 25 μm. In some examples, including any of the foregoing, the sintered film, or bilayer after sintering, has a thickness of about 20 μm. In some examples, including any of the foregoing, the sintered film, or bilayer after sintering, has a thickness less than 15 μm. In some examples, including any of the foregoing, the sintered film, or bilayer after sintering, has a thickness of about 10 μm. In some examples, including any of the foregoing, the sintered film, or bilayer after sintering, has a thickness of about 5 μm. In some examples, including any of the foregoing, the sintered film, or bilayer after sintering, has a thickness between 5 μm and 50 μm. In some examples, including any of the foregoing, the sintered film, or bilayer after sintering, has a thickness between 10 μm and 40 μm. In some examples, including any of the foregoing, the sintered film, or bilayer after sintering, has a thickness between 20 μm and 40 μm.

Herein, in some examples, the sintered film, or bilayer after sintering, has a thickness of 200 μm. In some examples, including any of the foregoing, the sintered film, or bilayer after sintering, has a thickness of 100 μm. In some examples, including any of the foregoing, the sintered film, or bilayer after sintering, has a thickness of 90 μm. In some examples, including any of the foregoing, the sintered film, or bilayer after sintering, has a thickness of 80 μm. In some examples, including any of the foregoing, the sintered film, or bilayer after sintering, has a thickness of 70 μm. In some examples, including any of the foregoing, the sintered film, or bilayer after sintering, has a thickness of 60 μm. In some examples, including any of the foregoing, the sintered film, or bilayer after sintering, has a thickness of 50 μm. In some examples, including any of the foregoing, the sintered film, or bilayer after sintering, has a thickness of 45 μm. In some examples, including any of the foregoing, the sintered film, or bilayer after sintering, has a thickness of 40 μm. In some examples, including any of the foregoing, the sintered film, or bilayer after sintering, has a thickness of 35 μm. In some examples, including any of the foregoing, the sintered film, or bilayer after sintering, has a thickness of 30 μm. In some examples, including any of the foregoing, the sintered film, or bilayer after sintering, has a thickness of 25 μm. In some examples, including any of the foregoing, the sintered film, or bilayer after sintering, has a thickness of 20 μm. In some examples, including any of the foregoing, the sintered film, or bilayer after sintering, has a thickness of 18 μm. In some examples, including any of the foregoing, the sintered film, or bilayer after sintering, has a thickness of 16 μm. In some examples, including any of the foregoing, the sintered film, or bilayer after sintering, has a thickness less than 15 μm. In some examples, including any of the foregoing, the sintered film, or bilayer after sintering, has a thickness of 10 μm. In some examples, including any of the foregoing, the sintered film, or bilayer after sintering, has a thickness of 5 μm. In some examples, including any of the foregoing, the sintered film, or bilayer after sintering, has a thickness between 5 μm and 50 μm. In some examples, including any of the foregoing, the sintered film, or bilayer after sintering, has a thickness between 10 μm and 40 μm. In some examples, including any of the foregoing, the sintered film, or bilayer after sintering, has a thickness between 20 μm and 40 μm. In some examples, including any of the foregoing, the sintered film, or bilayer after sintering, has a thickness between 10 μm and 60 μm. In some examples, including any of the foregoing, the sintered film, or bilayer after sintering, has a thickness between 10 μm and 70 μm. In some examples, including any of the foregoing, the sintered film, or bilayer after sintering, has a thickness between 10 μm and 80 μm. In some examples, including any of the foregoing, the sintered film, or bilayer after sintering, has a thickness between 20 μm and 60 μm. In some examples, including any of the foregoing, the sintered film, or bilayer after sintering, has a thickness between 20 μm and 70 μm. In some examples, including any of the foregoing, the sintered film, or bilayer after sintering, has a thickness between 20 μm and 80 μm.

In some of the methods disclosed herein, the thickness of the ceramic film in a bilayer after sintering is from about 10 μm to about 50 μm. In some of the methods disclosed herein, the thickness of the ceramic film in a bilayer after sintering is from about 20 μm to about 40 μm. In some of the methods disclosed herein, the thickness of the ceramic film in a bilayer after sintering is from about 20 μm to about 30 μm.

In some examples, including any of the foregoing, the sintered article comprises a bilayer. In examples, the bilayer includes a metal foil and a ceramic film. In some examples, the sintered article comprises a trilayer. In some examples, the metal is Ni. In some examples, the Ni is 1 μm thick. In some examples, the Ni is 2 μm thick. In some examples, the Ni is 3 μm thick. In some examples, the Ni is 4 μm thick. In some examples, the Ni is 5 μm thick. In some examples, the Ni is 6 μm thick. In some examples, the Ni is 7 μm thick. In some examples, the Ni is 8 μm thick. In some examples, the Ni is 9 μm thick. In some examples, the Ni is 10 μm thick. In some examples, the Ni is 11 μm thick. In some examples, the Ni is 12 μm thick. In some examples, the Ni is 13 μm thick. In some examples, the Ni is 14 μm thick. In some examples, the Ni is 15 μm thick. In some examples, the Ni is 16 μm thick. In some examples, the Ni is 17 μm thick. In some examples, the Ni is 18 μm thick. In some examples, the Ni is 19 μm thick. In some examples, the Ni is 20 μm thick.

In some examples, the green film is a bilayer or a trilayer.

In some examples, various layer architectures can be envisioned and sintered according to the sintering methods set forth herein: A) free-standing lithium stuffed garnet material; B) free-standing lithium stuffed garnet material which optionally includes an active material, a binder, a solvent, and, or, carbon; C) a bilayer having one layer of a lithium stuffed garnet and one layer of a metal powder, foil or sheet; D) a bilayer having one layer of a lithium stuffed garnet and one layer comprising a metal powder, foil or sheet, E) a bilayer having one layer of a lithium stuffed garnet material which optionally includes an active material, a binder, a solvent, and, or, carbon and one layer of a metal powder, foil, or sheet; F) a trilayer having two layers of a lithium stuffed garnet and one layer of a metal powder, foil or sheet, between and in contact with the garnet layers; G) a trilayer having two layers of a lithium stuffed garnet and one layer comprising a metal powder, foil or sheet, between and in contact with the garnet layers; and H) a trilayer having two layers of a lithium stuffed garnet material wherein each garnet layer optionally includes an active material, a binder, a solvent, and, or, carbon and one layer of a metal powder, foil, or sheet, between and in contact with the garnet layers.

A trilayer may comprises a layer of lithium-stuffed garnet, a metal layer, and a second layer of lithium-stuffed garnet on the opposite side of the metal layer.

A bilayer may comprise a layer of lithium-stuffed garnet and a layer of metal foil. In some examples, a metal layer comprises Ni, Fe, Cu, Al, Sn, In, Ag, Au, steel, alloys, or combinations thereof. For example, the metal layer may include Ni and Fc. For example, the metal layer may include 90% Ni and 10% Fe. For example, the metal layer may include Ni and Fe. For example, the metal layer may include 91% Ni and 9% Fe. For example, the metal layer may include Ni and Fe. For example, the metal layer may include 92% Ni and 8% Fe. For example, the metal layer may include Ni and Fe. For example, the metal layer may include 93% Ni and 7% Fe. For example, the metal layer may include Ni and Fe. For example, the metal layer may include 94% Ni and 6% Fe. For example, the metal layer may include Ni and Fe. For example, the metal layer may include 95% Ni and 5% Fe. For example, the metal layer may include Ni and Fe. For example, the metal layer may include 96% Ni and 4% Fe. For example, the metal layer may include Ni and Fe. For example, the metal layer may include 97% Ni and 3% Fe. For example, the metal layer may include Ni and Fe. For example, the metal layer may include 98% Ni and 2% Fe. For example, the metal layer may include Ni and Fe. For example, the metal layer may include 99% Ni and 1% Fe. In some examples, a metal layer is a sheet of metal. In some examples, a metal layer is a sheet of aluminum. In some examples, a metal layer is a sheet of nickel. In some examples, a metal layer may be malleable. In some examples, the metal layer is 1 μm thick. In some examples, the metal layer is 2 μm thick. In some examples, the metal layer is 3 μm thick. In some examples, the metal layer is 4 μm thick. In some examples, the metal layer is 5 μm thick. In some examples, the metal layer is 6 μm thick. In some examples, the metal layer is 7 μm thick. In some examples, the metal layer is 8 μm thick. In some examples, the metal layer is 9 μm thick. In some examples, the metal layer is 10 μm thick. In some examples, the metal layer is 11 μm thick. In some examples, the metal layer is 12 μm thick. In some examples, the metal layer is 13 μm thick. In some examples, the metal layer is 14 μm thick. In some examples, the metal layer is 15 μm thick. In some examples, the metal layer is 16 μm thick. In some examples, the metal layer is 17 μm thick. In some examples, the metal layer is 18 μm thick. In some examples, the metal layer is 19 μm thick. In some examples, the metal layer is 20 μm thick.

In some examples, the lithium-stuffed garnet-metal sintered films herein are 1 μm to 100 μm in thickness. In certain examples, these films are co-sintered with a mixed amount of lithium-stuffed garnet and a metal. The metal may be selected from the group consisting of Ni, Mg, Li, Fe, Al, Cu, Au, Ag, Pd, Pt, Ti, steel, alloys thereof, and combination thereof. The lithium-stuffed garnet and metal are mixed as powders and then co-sintered to form a film. In some examples, the film includes a uniform mixture of lithium-stuffed garnet and metal. The relative amounts of lithium-stuffed garnet and metal may vary by volume percent from 1% lithium-stuffed garnet up to 99% lithium-stuffed garnet with the remainder being the metal.

In some examples, including any of the foregoing, lithium-stuffed garnet is sintered onto a ceramic-metal film.

These materials include but are not limited to bilayers of a lithium-stuffed garnet film on a metal layer or trilayers of a metal layer between two lithium-stuffed garnet films. The systems and processes set forth herein are useful for making lithium-stuffed garnet films or composite materials, including but not limited to any of the sintered films or film-including materials set forth in PCT/US2016/043428, filed Jul. 21, 2016, and published as WO2017015511A1—titled Processes and materials for casting and sintering green garnet thin films; PCT/US2019/056584, filed Oct. 16, 2019, and published as WO2020081718A1—titled Sintering large area ceramic films; PCT/US2016/15209, filed Jan. 27, 2016, and published as WO2017131676A1—titled Annealed garnet electrolyte separators; PCT/US2017/039069, filed Jan. 23, 2017, and published as WO2018236394A1—titled Lithium-stuffed garnet electrolytes with secondary phase inclusions. PCT/US2019/54117, filed Oct. 1, 2019, and published as WO2020072524A1—titled Methods of making and using an electrochemical cell comprising an interlayer; U.S. Pat. Nos. 10,403,931; 10,290,895; 9,966,630 B2; 10,347,937 B2; and 10,103,405, the entire contents of each of which are herein incorporate by reference in their entirety for all purposes.

In some examples, including any of the foregoing, the ceramic-metal film may be an oxide-metal film. In some examples, the film has one layer that is a ceramic and one layer that is a metal. In other examples, the film is a homogenous mixture of ceramic and metal. In some examples, the ceramic-metal film comprises a ceramic and a metal. In some examples, the volume percent of the ceramic is 10% and the volume percent of the metal is 90%. In some examples, the volume percent of the ceramic is 20% and the volume percent of the metal is 80%. In some examples, the volume percent of the ceramic is 30% and the volume percent of the metal is 70%. In some examples, the volume percent of the ceramic is 40% and the volume percent of the metal is 60%. In some examples, the volume percent of the ceramic is 50% and the volume percent of the metal is 50%. In some examples, the volume percent of the ceramic is 60% and the volume percent of the metal is 40%. In some examples, the volume percent of the ceramic is 70% and the volume percent of the metal is 30%. In some examples, the volume percent of the ceramic is 80% and the volume percent of the metal is 20%. In some examples, the volume percent of the ceramic is 90% and the volume percent of the metal is 10%. In some examples, the volume percent of the ceramic is 5% and the volume percent of the metal is 95%. In some examples, the volume percent of the ceramic is 15% and the volume percent of the metal is 85%. In some examples, the volume percent of the ceramic is 25% and the volume percent of the metal is 75%. In some examples, the volume percent of the ceramic is 35% and the volume percent of the metal is 65%. In some examples, the volume percent of the ceramic is 45% and the volume percent of the metal is 55%. In some examples, the volume percent of the ceramic is 55% and the volume percent of the metal is 45%. In some examples, the volume percent of the ceramic is 65% and the volume percent of the metal is 32%. In some examples, the volume percent of the ceramic is 75% and the volume percent of the metal is 25%. In some examples, the volume percent of the ceramic is 85% and the volume percent of the metal is 15%. In some examples, the volume percent of the ceramic is 95% and the volume percent of the metal is 5%.

In some examples, including any of the foregoing, the ceramic-metal film comprises an oxide and a metal. In some examples, the volume percent of the oxide is 10% and the volume percent of the metal is 90%. In some examples, the volume percent of the oxide is 20% and the volume percent of the metal is 80%. In some examples, the volume percent of the oxide is 30% and the volume percent of the metal is 70%. In some examples, the volume percent of the oxide is 40% and the volume percent of the metal is 60%. In some examples, the volume percent of the oxide is 50% and the volume percent of the metal is 50%. In some examples, the volume percent of the oxide is 60% and the volume percent of the metal is 40%. In some examples, the volume percent of the oxide is 70% and the volume percent of the metal is 30%. In some examples, the volume percent of the oxide is 80% and the volume percent of the metal is 20%. In some examples, the volume percent of the oxide is 90% and the volume percent of the metal is 10%. In some examples, the volume percent of the oxide is 5% and the volume percent of the metal is 95%. In some examples, the volume percent of the oxide is 15% and the volume percent of the metal is 85%. In some examples, the volume percent of the oxide is 25% and the volume percent of the metal is 75%. In some examples, the volume percent of the oxide is 35% and the volume percent of the metal is 65%. In some examples, the volume percent of the oxide is 45% and the volume percent of the metal is 55%. In some examples, the volume percent of the oxide is 55% and the volume percent of the metal is 45%. In some examples, the volume percent of the oxide is 65% and the volume percent of the metal is 32%. In some examples, the volume percent of the oxide is 75% and the volume percent of the metal is 25%. In some examples, the volume percent of the oxide is 85% and the volume percent of the metal is 15%. In some examples, the volume percent of the oxide is 95% and the volume percent of the metal is 5%.

In some examples, including any of the foregoing, the ceramic-metal film may be an oxide-metal film. In some examples, the ceramic-metal film comprises a ceramic and a metal. In some examples, the weight percent of the ceramic is 10% and the weight percent of the metal is 90%. In some examples, the weight percent of the ceramic is 20% and the weight percent of the metal is 80%. In some examples, the weight percent of the ceramic is 30% and the weight percent of the metal is 70%. In some examples, the weight percent of the ceramic is 40% and the weight percent of the metal is 60%. In some examples, the weight percent of the ceramic is 50% and the weight percent of the metal is 50%. In some examples, the weight percent of the ceramic is 60% and the weight percent of the metal is 40%. In some examples, the weight percent of the ceramic is 70% and the weight percent of the metal is 30%. In some examples, the weight percent of the ceramic is 80% and the weight percent of the metal is 20%. In some examples, the weight percent of the ceramic is 90% and the weight percent of the metal is 10%. In some examples, the weight percent of the ceramic is 5% and the weight percent of the metal is 95%. In some examples, the weight percent of the ceramic is 15% and the weight percent of the metal is 85%. In some examples, the weight percent of the ceramic is 25% and the weight percent of the metal is 75%. In some examples, the weight percent of the ceramic is 35% and the weight percent of the metal is 65%. In some examples, the weight percent of the ceramic is 45% and the weight percent of the metal is 55%. In some examples, the weight percent of the ceramic is 55% and the weight percent of the metal is 45%. In some examples, the weight percent of the ceramic is 65% and the weight percent of the metal is 32%. In some examples, the weight percent of the ceramic is 75% and the weight percent of the metal is 25%. In some examples, the weight percent of the ceramic is 85% and the weight percent of the metal is 15%. In some examples, the weight percent of the ceramic is 95% and the weight percent of the metal is 5%.

In some examples, including any of the foregoing, the ceramic in the ceramic-metal film may be selected from alumina, silica, titania, lithium-stuffed garnet, lithium aluminate, aluminum hydroxide, an aluminosilicate, lithium zirconate, lanthanum aluminate, lanthanum zirconate, lanthanum oxide, lithium lanthanum oxide, zirconia, Li₂ZrO₃, xLi₂O-(1-x)SiO₂ (where x=0.01-0.99), aLi₂O-bB₂O₃-cSiO₂ (where a+b+c=1), LiLaO₂, LiAlO₂, Li₂O, Li₃PO₄, or combinations thereof.

In examples, the trilayer includes a metal foil and a green ceramic film on both sides of the metal foil. A metal foil in a bilayer or trilayer may have a thickness of between 0.5 μm to 50 μm. A metal foil in a bilayer or trilayer may have a thickness of between 3 μm to 30 μm. In some examples, the metal foil in a bilayer or trilayer may have a thickness of between 5-20 μm. In other examples, the metal foil in a bilayer or trilayer may have a thickness of between 5 μm to 15 μm.

In some examples, including any of the foregoing, the sintered article comprises LLZO.

In some examples, the sintered film has a D₅₀ grain size less than 5 μm. In some examples, the sintered film has a D₅₀ grain size less than 4 μm. In some examples, the sintered film has a D₅₀ grain size less than 3 μm. In some examples, the sintered film has a D₅₀ grain size less than 2 μm. In some examples, the sintered film has a D₅₀ grain size less than 1 μm. In some examples, the sintered film has a D₅₀ grain size less than 0.9 μm. In some examples, the sintered film has a D₅₀ grain size less than 0.8 μm. In some examples, the sintered film has a D₅₀ grain size less than 0.7 μm. In some examples, the sintered film has a D₅₀ grain size less than 0.6 μm. In some examples, the sintered film has a D₅₀ grain size less than 0.5 μm. In some examples, the sintered film has a D₅₀ grain size less than 0.4 μm. In some examples, the sintered film has a D₅₀ grain size less than 0.3 μm. In some examples, the sintered film has a D₅₀ grain size less than 0.2 μm. In some examples, the sintered film has a D₅₀ grain size less than 0.1 micron. In some examples, the sintered film has a D₉₀ grain size less than 5 μm. In some examples, the sintered film has a Doo grain size less than 4 μm. In some examples, the sintered film has a Doo grain size less than 3 μm. In some examples, the sintered film has a Doo grain size less than 2 μm. In some examples, the sintered film has a D₉₀ grain size less than 1 μm. In some examples, the sintered film has a Doo grain size less than 0.9 μm. In some examples, the sintered film has a D₉₀ grain size less than 0.8 μm. In some examples, the sintered film has a D₉₀ grain size less than 0.7 μm. In some examples, the sintered film has a Doo grain size less than 0.6 μm. In some examples, the sintered film has a Doo grain size less than 0.5 μm. In some examples, the sintered film has a Doo grain size less than 0.4 μm. In some examples, the sintered film has a D₉₀ grain size less than 0.3 μm. In some examples, the sintered film has a Doo grain size less than 0.2 μm. In some examples, the sintered film has a Deo grain size less than 0.1 micron. In some examples, the sintered film has a porosity of less than 5%. In some examples, the sintered film has a porosity of 1 less than 4%. In some examples, the sintered film has a porosity of less than 3%. In some examples, the sintered film has a porosity of less than 2%. In some examples, the sintered film has a porosity of less than 1%. In some examples, the sintered film has a porosity of less than 0.5%. In some examples, the sintered film has a porosity of less than 0.4%. In some examples, the sintered film has a porosity of less than 0.3%. In some examples, the sintered film has a porosity of less than 0.2%. In some examples, the sintered film has a density of greater than 95%. In some examples, the sintered film has a density of greater than 96%. In some examples, the sintered film has a density of greater than 97%. In some examples, the sintered film has a density of greater than 98%. In some examples, the sintered film has a density of greater than 99%. In some examples, the sintered film has a density of greater than 99.5%. In some examples, the sintered film has a density of greater than 99.6%. In some examples, the sintered film has a density of greater than 99.7%. In some examples, the sintered film has a density of greater than 99.8%. In some examples, the sintered film has a density of greater than 99.9%.

In some examples, a roll of sintered film may further comprise additional padding material.

In some examples, including any of the foregoing, the sintered film has a D₅₀ grain size of less than 5 microns (μm).

In some examples, including any of the foregoing, the sintered film has a D₉₀ grain size of less than 5 μm.

In some examples, including any of the foregoing, the sintered film has a porosity of less than 5% by volume.

In some examples, including any of the foregoing, the sintered film has a defect density of fewer than 100 protrusions per square centimeter from the surface with an aspect ratio (height/diameter) of greater than 1.

In some examples, including any of the foregoing, the sintered film has a defect density of fewer than 100 valleys per square centimeter from the surface with an aspect ratio (height/diameter) greater than 1.

In some examples, including any of the foregoing, the sintered film has a defect density of fewer than 100 protrusions per square centimeter at the interface between a lithium-stuffed garnet film and a metal layer with an aspect ratio (height/diameter) of greater than 1.

In some examples, including any of the foregoing, the sintered film has a defect density of fewer than 100 valleys per square centimeter the interface between a lithium-stuffed garnet film and a metal layer with an aspect ratio (height/diameter) greater than 1.

In some examples, including any of the foregoing, the D₅₀ grain size is at least 10 nm.

In some examples, including any of the foregoing, the D₅₀ grain size is at least 50 nm.

In some examples, including any of the foregoing, the D₅₀ grain size is at least 1 μm.

### Sintered Lithium-Stuffed Garnet on Metal Foil

The methods disclosed herein may be used to sinter lithium-stuffed garnet on a metal foil. In some examples, the metal foil is a densified metal layer. In certain examples, the metal foil is a densified metal layer that also includes a ceramic. In some of these examples, the ceramic is a lithium-stuffed garnet.

In some examples, the metal foil or metal layer is nickel, steel, stainless steel, copper, aluminum, Kovar, Invar, ceramic, Haynes216, or a combination thereof.

In certain examples, the LLZO is sintered on a metal foil. In some of these examples, the metal foil is pure Ni. In some of these examples, the metal foil is a combination of Ni and Fe. In some of these examples, the metal foil is Ni/Fe 93%/7%.

In certain examples, the LLZO is sintered on a metal foil. In some of these examples, the metal foil is pure Cu. In some of these examples, the metal foil is Cu/Fe 93%/7%. In some of these examples, the metal foil is a combination of Cu and Fe.

In some examples, CTE matching is used to prevent curvature from forming in the sintered film. CTE matching includes making the two layers' coefficients of thermal expansion (CTE) the same. The interface between the two layers gets formed/fixed during sintering at >1000C. As the film then cools down to room temperature, if the CTEs aren't the same, one layer will contract a little more than the other, creating a film that is curved to one side (the one that contracted more), which is undesirable.

Herein, “Invar” is a Ni/Fe material.

In some examples, the green tape which is described above as deposited on mylar foil is instead deposited onto a metal layer. The metal may be nickel, steel, stainless steel, copper, aluminum, Kovar, Invar, ceramic, ceramic on metal, Haynes216, LLZO, LLZO on Ni, or a combination thereof. In this example, the green tape does not need to be peeled off mylar and can instead be directly sintered on the metal. The green tape the metal may be rolled up together before the green tape is moved through the CML. In some examples, a backing layer is applied to the metal which is rolled up with a green tape on the metal. In some examples, an interleaf layer is used when the metal with a green tape on the metal is rolled up. The interleaf provides padding between the layers which are rolled up.

Sintered Lithium-Stuffed Garnet with No Underlying Substrate

In some examples, the methods and systems herein sinter lithium-stuffed garnet with no underlying substrate.

Sintered Lithium-Stuffed Garnet with a Co-Sintered Current Collector

In some examples, the disclosure herein uses sintered lithium-stuffed garnet layer adjacent to a co-sintered current collector (CSC). The CSC layer may comprise Ni in 0.0001-25% by weight, Fe in 1-25% by weight, or combinations thereof. In some cases, the CSC layer comprises 1-20 weight % of Ni and 1-10 weight % of Fc and the remainder is lithium-stuffed garnet. In some cases, the CSC layer comprises 5-15 weight % of Ni and 1-5 weight % of Fe and the remainder is lithium-stuffed garnet. In some cases, the CSC layer comprises 10-15 weight % of Ni and 3-5 weight % of Fe and the remainder is lithium-stuffed garnet.

Other configurations are contemplated herein. For example, a bare film configuration may be as follows: a sintered LLZO film with no other, metal-containing layers.

For example, a CSC or co-sintering configuration may include a bilayer of green LLZO and green metal-ceramic layer. The metal-ceramic layer is a metal and ceramic powder while in green state.

For example, an on-foil configuration may be as follows. This includes casting a green LLZO on a metal layer/foil. The metal layer is a dense layer, not a powder. The foil in this case has no ceramic in it, can be purchased, and is typically made by processes other than sintering (e.g., electrodeposition or roll-annealing). For example, an on-foil configuration is possible as well with a ceramic-metal foil. This includes using a normal metal foil, starting out with a metal-ceramic foil, and hence the resulting final product similar to CSC.

### Setters

In some embodiments described herein, the setter plates may, include a member selected from Li₂ZrO₃, xLi₂O-(1-x)SiO₂ (where x=0.01-0.99), aLi₂O-bB₂O₃-cSiO₂ (where a+b+c=1), LiLaO₂, LiAlO₂, Li₂O, Li₃PO₄, a Li-stuffed garnet, or combinations thereof. In some embodiments, the setter plates comprise Li₂ZrO₃. In some embodiments, the setter plates comprise Li₂SiO₃. In some embodiments, the setter plates comprise LiLaO₂. In some embodiments, the setter plates comprise LiAlO₂. In some embodiments, the setter plates comprise Li₂O. In some embodiments, the setter plates comprise Li₃PO₄. In some embodiments, the setter plates comprise a Li-stuffed garnet. In some embodiments, the setter plates comprise at least two, three, four or more of Li₂ZrO₃, Li₂SiO₃, LiLaO₂, LiAlO₂, Li₂O, Li₃PO₄, and a Li-stuffed garnet. Additionally, these setter plates should not induce a chemical potential in the sintering film which results in Li diffusion out of the sintering film, for example, into the setter plate.

In some embodiments, the instant disclosure provides a setter plate suitable for use for fabricating solid electrolytes of a rechargeable battery, wherein the setter plate includes a Li-stuffed garnet compound characterized by the formula LiₓLa_{y}Zr_{z}Oₜ·qAl₂O₃, wherein 4<x<10, 1<y<4, 1<z<3, 6<t<14, and 0≤q≤1. In some embodiments, the setter plate has a surface defined by a first lateral dimension from 2 cm to 30 cm and a second lateral dimension from 2 cm to 30 cm; and a thickness from 0.1 mm to 100 mm.

In some embodiments, the instant disclosure provides a setter plate, including any of the setter plates set forth in U.S. Pat. No. 10,563,918 B2, which is herein incorporated by reference in its entirety for all purposes.

### Method of Using

In some embodiments, including any of the foregoing, set forth herein is a method of sintering a bilayer, comprising providing, or having provided, a stack disclosed herein, and sintering the bilayer.

The embodiments and examples described above are intended to be merely illustrative and non-limiting. Those skilled in the art will recognize or will be able to ascertain using no more than routine experimentation, numerous equivalents of specific compounds, materials and procedures. All such equivalents are considered to be within the scope and are encompassed by the appended claims.

1. A stack comprising:
a bottom setter comprising at least one or more refractory materials;
a bilayer disposed on the bottom setter, wherein the bilayer comprises:
a layer comprising an oxide, and
a layer comprising a metal;
a top setter disposed on the bilayer, wherein the top setter has a perimeter but does not have a center.

2. The stack of claim 1, wherein the layer comprising an oxide does not comprise a metal in the layer comprising an oxide.

3. The stack of claim 2, wherein the layer comprising an oxide consists of an oxide.

4. The stack of claim 2 or 3, wherein the layer comprising an oxide consists essentially of an oxide.

5. The stack of any one of claims 1-4, wherein the layer comprising an oxide comprises a lithium-stuffed garnet oxide.

6. The stack of any one of claim 1 or 4-5, wherein the layer comprising an oxide further comprises metal in the layer comprising an oxide.

7. The stack of claim 6, wherein the metal in the layer comprising an oxide is selected from the group consisting of nickel (Ni), iron (Fe), copper (Cu), titanium (Ti), zirconium (Zr), and combinations thereof.

8. The stack of claim 6 or 7, wherein the metal in the layer comprising an oxide is Ni.

9. The stack of claim 6 or 7, wherein the metal in the layer comprising an oxide is Fe.

10. The stack of any one of claim 6 or 7-9, comprising more than one type of metal in the layer comprising an oxide.

11. The stack of any one of claims 1-10, wherein the layer comprising a metal comprises a metal selected from the group consisting of nickel (Ni), iron (Fe), copper (Cu), titanium (Ti), zirconium (Zr), and combinations thereof.

12. The stack of claim 11, wherein the layer comprising a metal comprises Ni.

13. The stack of claim 11, wherein the layer comprising a metal comprises Fe.

14. The stack of claim 11, wherein the layer comprising a metal comprises Cu.

15. The stack of any one of claims 1-14, wherein the top setter is a metallic foam.

16. The stack of any one of claims 1-15, wherein the top setter is a nickel (Ni) foam.

17. The stack of any one of claims 1-16, wherein, the refractory materials are, individually, selected from the group consisting of Al₂O₃, LiAlO₂, Li₇La₃Zr₂O₁₂, Li₂ZrO₃, xLi₂O-(1-x)SiO₂ (where x=0.01-0.99), aLi₂O-bB₂O₃-cSiO₂ (where a+b+c=1), LiLaO₂, Li₂O, Li₃PO₄, ZrO₂, ZnO₂, and combinations thereof.

18. The stack of any one of claims 1-17, wherein, the top setter comprises a refractory materials selected from the group consisting of Al₂O₃, LiAlO₂, Li₇La₃Zr₂O₁₂, Li₂ZrO₃, xLi₂O-(1-x)SiO₂ (where x=0.01-0.99), aLi₂O-bB₂O₃-cSiO₂ (where a+b+c=1), LiLaO₂, LiAlO₂, Li₂O, Li₃PO₄, ZrO₂, ZnO₂, and combinations thereof.

19. The stack of claim 17 or 18, wherein the refractory materials comprise LiAlO₂.

20. The stack of any one of claims 1-19, further comprising at least one or more shims disposed between the top setter and the bottom setter.

21. The stack of any one of claims 1-20, further comprising a third setter comprising at least one or more refractory materials disposed above the top setter.

22. The stack of claim 21, further comprising a layer comprising a shim disposed above the top setter and between the top setter and the third setter comprising at least one or more refractory materials disposed above the top setter.

23. Two or more stacks of any one of claims 1-22, wherein the two or more stacks are stacked on top of each other.

24. A stack comprising:
a bottom setter;
a bilayer disposed on the bottom setter, wherein the bilayer comprises:
a layer comprising an oxide, and
a layer comprising a metal;
a metallic mesh disposed on the electrolyte bilayer.

25. The stack of claim 24, wherein the metal mesh comprises Ni.

26. The stack of claim 24 or 25, wherein the metal mesh is a metallic foam.

27. The stack of any one of claims 24-26, wherein the layer comprising an oxide does not comprise a metal in the layer comprising an oxide.

28. The stack of any one of claims 24-26, wherein the layer comprising an oxide consists of an oxide.

29. The stack of any one of claims 24-28, wherein the layer comprising an oxide consists essentially of an oxide.

30. The stack of any one of claims 24-29, wherein the layer comprising an oxide comprises a lithium-stuffed garnet oxide.

31. The stack of any one of claim 24-26 or 28-30, wherein the layer comprising an oxide further comprises metal in the layer comprising an oxide.

32. The stack of claim 31, wherein the metal in the layer comprising an oxide is selected from the group consisting of nickel (Ni), iron (Fe), copper (Cu), titanium (Ti), zirconium (Zr), and combinations thereof.

33. The stack of claim 31 or 32, wherein the metal in the layer comprising an oxide is Ni.

34. The stack of claim 31 or 32, wherein the metal in the layer comprising an oxide is Fe.

35. The stack of claim 31 or 32, comprising more than one type of metal in the layer comprising an oxide.

36. The stack of any one of claims 24-35, wherein the layer comprising a metal comprises a metal selected from the group consisting of nickel (Ni), iron (Fe), copper (Cu), titanium (Ti), zirconium (Zr), and combinations thereof.

37. The stack of claim 36, wherein the layer comprising a metal comprises Ni.

38. The stack of claim 36, wherein the layer comprising a metal comprises Fe.

39. The stack of claim 36, wherein the layer comprising a metal comprises Cu.

40. The stack of any one of claims 24-39, wherein the bottom setter comprises one or more refractory materials, wherein the refractory materials are selected from the group consisting of Al₂O₃, LiAlO₂, Li₇La₃Zr₂O₁₂, Li₂ZrO₃, xLi₂O-(1-x)SiO₂ (where x=0.01-0.99), aLi₂O-bB₂O₃-cSiO₂ (where a+b+c=1), LiLaO₂, Li₂O, Li₃PO₄, ZrO₂, ZnO₂, and combinations thereof.

41. The stack of any one of claims 24-40, wherein, the top setter comprises one or more refractory materials selected from Al₂O₃, LiAlO₂, Li₇La₃Zr₂O₁₂, Li₂ZrO₃, xLi₂O-(1-x)SiO₂ (where x=0.01-0.99), aLi₂O-bB₂O₃-cSiO₂ (where a+b+c=1), LiLaO₂, Li₂O, Li₃PO₄, ZrO₂, ZnO₂, or combinations thereof.

42. The stack of claim 40 or 41, wherein the refractory material comprises LiAlO₂.

43. The stack of any one of claims 24-42, further comprising at least one or more shims disposed between the metallic mesh and the bottom setter.

44. The stack of any one of claims 24-42, further wherein the metallic mesh contacts the bilayer.

45. The stack of any one of claims 24-44, further comprising a setter comprising at least one or more refractory materials disposed above the metallic mesh.

46. The stack of claim 45, further comprising a layer comprising a shim disposed above the metallic mesh and between the metallic mesh and the setter comprising at least one or more refractory materials disposed above the metallic mesh.

47. Two or more stacks of any one of claims 24-46, wherein the two or more stacks are stacked on top of each other.

48. A stack comprising:
a bottom setter;
a bilayer disposed on the bottom setter, wherein the bilayer comprises:
a layer comprising an oxide, and
a layer comprising a metal;
at least one or more shims comprising a refractory material disposed above the bilayer.

49. A stack comprising:
a bottom setter;
a bilayer disposed on the bottom setter, wherein the bilayer comprises:
a layer comprising an oxide, and
a layer comprising a metal;
at least one or more shims comprising a refractory material disposed around the bilayer.

50. The stack of any one of claims 48-49, wherein the layer comprising an oxide does not comprise a metal in the layer comprising an oxide.

51. The stack of any one of claims 48-49, wherein the layer comprising an oxide consists of an oxide.

52. The stack of any one of claims 48-49, wherein the layer comprising an oxide consists essentially of an oxide.

53. The stack of any one of claims 48-52, wherein the layer comprising an oxide comprises a lithium-stuffed garnet oxide.

54. The stack of any one of claim 48-49 or 53, wherein the layer comprising an oxide further comprises metal in the layer comprising an oxide.

55. The stack of claim 54, wherein the metal in the layer comprising an oxide is selected from the group consisting of nickel (Ni), iron (Fe), copper (Cu), titanium (Ti), zirconium (Zr), and combinations thereof.

56. The stack of claim 54 or 55, wherein the metal in the layer comprising an oxide is Ni.

57. The stack of claim 54 or 55, wherein the metal in the layer comprising an oxide is Fe.

58. The stack of claim 54 or 55, comprising more than one type of metal in the layer comprising an oxide.

59. The stack of any one of claims 48-58, wherein the layer comprising a metal comprises a metal selected from the group consisting of nickel (Ni), iron (Fe), copper (Cu), titanium (Ti), zirconium (Zr), and combinations thereof.

60. The stack of claim 59, wherein the layer comprising a metal comprises Ni.

61. The stack of claim 59, wherein the layer comprising a metal comprises Fe.

62. The stack of claim 59, wherein the layer comprising a metal comprises Cu.

63. The stack of any one of claims 48-62, further comprising a top setter disposed on top of the at least one or more shims comprising a refractory material.

64. The stack of any one of claim 63, wherein the top setter is a metallic foam.

65. The stack of any one of claims 63-64, wherein the top setter is a nickel (Ni) foam.

66. The stack of any one of claims 48-65, wherein, the refractory materials are selected from Al₂O₃, LiAlO₂, Li₇La₃Zr₂O₁₂, Li₂ZrO₃, xLi₂O-(1-x)SiO₂ (where x=0.01-0.99), aLi₂O-bB₂O₃-cSiO₂ (where a+b+c=1), LiLaO₂, Li₂O, Li₃PO₄, ZrO₂, ZnO₂, or combinations thereof.

67. The stack of any one of claims 48-66, wherein, the top setter comprises a refractory materials selected from Al₂O₃, LiAlO₂, Li₇La₃Zr₂O₁₂, Li₂ZrO₃, xLi₂O-(1-x)SiO₂ (where x=0.01-0.99), aLi₂O-bB₂O₃-cSiO₂ (where a+b+c=1), LiLaO₂, Li₂O, Li₃PO₄, ZrO₂, ZnO₂, or combinations thereof.

68. The stack of claim 66 or 67, wherein the refractory material comprises LiAlO₂.

69. The stack of any one of claims 63-68, further comprising a third setter comprising at least one or more refractory materials disposed above the top setter.

70. The stack of claim 69, further comprising a layer comprising a shim disposed above the top setter and between the top setter and an additional layer comprising at least one or more refractory materials disposed above the top setter.

71. Two or more stacks of any one of claims 48-70, wherein the two or more stacks are stacked on top of each other.

72. The stack of any one of claims 1-71, wherein the bilayer is oriented so that the layer comprising an oxide contacts the bottom setter.

73. The stack of any one of claims 1-71, wherein the bilayer is oriented so that the layer comprising a metal contacts the bottom setter.

74. The stack of any one of claims 1-73, wherein the layer comprising a metal comprises a metal selected from the group consisting of nickel (Ni), iron (Fe), copper (Cu), platinum (Pt), gold (Au), silver), an alloy thereof, or a combination thereof.

75. The stack of any one of claims 1-74, wherein the layer comprising a metal is an alloy of Fe and Ni.

76. The stack of any one of claims 1-75, wherein the layer comprising a metal is an alloy of Fe and Ni, and the amount of Fe is 1% to 25% (w/w) with the remainder being Ni.

77. The stack of any one of claims 1-76, wherein the thickness of the layer comprising a metal is 1 μm to 20 μm.

78. The stack of any one of claims 1-77, wherein the thickness of the layer comprising a metal is 1 μm to 10 μm.

79. The stack of any one of claims 1-78, wherein the thickness of the layer comprising a metal is 5 μm to 10 μm.

80. The stack of any one of claims 1-79, wherein the bilayer is less than 200 μm thick.

81. The stack of any one of claims 1-80, wherein the layer comprising a metal is 10% or less by weight (w/w) of the total weight of the bilayer.

82. The stack of any one of claims 1-81, wherein the bilayer has an area-specific resistance of less than 20 Ω-cm² at room temperature.

83. The stack of any one of claims 1-82, wherein the bilayer has an area-specific resistance of less than 20 Ω-cm² at 20° C.

84. The stack of any one of claims 1-83, wherein the thickness of the bilayer is about 30 μm to 50 μm thick.

85. The stack of any one of claims 1-84, wherein the thickness of the bilayer is about 30 μm, 40 μm, or 50 μm thick.

86. The stack of any one of claims 1-85, wherein the surface of the bilayer opposite the layer comprising a metal is free of defects.

87. The stack of any one of claims 1-86, wherein the bilayer has a D₉₀ ceramic grain size of about 50 μm.

88. The stack of any one of claims 1-87, wherein the bilayer has a Do ceramic grain size of about 25 μm.

89. The stack of any one of claims 1-88, wherein the bilayer has a D₉₀ ceramic grain size of about 5 μm.

90. The stack of any one of claims 1-89, wherein the bilayer comprises sintered lithium-stuffed garnet oxide.

91. The stack of any one of claims 1-90, wherein the bilayer has a porosity of less than 5% by volume as determined by scanning electron microscopy (SEM).

92. The stack of any one of claims 1-91, wherein the bilayer has a porosity of less than 0% as measured by BET surface area analysis.

93. The stack of any one of claims 1-92, wherein the bilayer has a porosity of less than 0% by volume as measured by a helium leak test.

94. The stack of any one of claims 1-93, wherein the layer comprising an oxide comprises lithium-stuffed garnet and comprises no defects on the lithium-stuffed garnet over a 100 mm² area.

95. The stack of any one of claims 1-94, wherein the layer comprising an oxide comprises lithium-stuffed garnet and comprises no defects on the lithium-stuffed garnet over a 100 cm² area.

96. The stack of any one of claims 1-95, wherein the layer comprising an oxide comprises lithium-stuffed garnet and comprises no defects on the lithium-stuffed garnet over a 100 mm² area.

97. The stack of any one of claims 1-96, wherein the layer comprising an oxide comprises lithium-stuffed garnet having a D₉₀ grain size of about 50 μm.

98. The stack of any one of claims 1-97, wherein the layer comprising an oxide comprises lithium-stuffed garnet having a D₉₀ grain size of about 25 μm.

99. The stack of any one of claims 1-98, wherein the layer comprising an oxide comprises lithium-stuffed garnet having a D₉₀ grain size of about 5 μm.

100. The stack of any one of claims 1-99, wherein the bilayer comprises lithium-stuffed garnet oxide.

101. The stack of any one of claims 1-100, wherein the bilayer has a porosity of less than 5% by volume as determined by scanning electron microscopy (SEM).

102. The stack of any one of claims 1-101, wherein the bilayer has a porosity of 0% by volume as measured by BET surface area analysis.

103. The stack of any one of claims 1-102, wherein the bilayer has a porosity of 0% by volume as measured by a helium leak test.

104. The stack of any one of claims 1-103, wherein the layer comprising an oxide comprises lithium-stuffed garnet having a defect density of fewer than 100 protrusions per square centimeter from the surface with an aspect ratio (height/diameter) of greater than 1.

105. The stack of any one of claims 1-104, wherein the layer comprising an oxide comprises lithium-stuffed garnet having a defect density of fewer than 100 valleys per square centimeter from the surface with an aspect ratio (height/diameter) greater than 1.

106. The stack of any one of claims 1-105, wherein the layer comprising an oxide comprises lithium-stuffed garnet having a D₅₀ grain size that is at least 10 nm.

107. The stack of any one of claims 1-106, wherein the layer comprising an oxide comprises lithium-stuffed garnet having a D₅₀ grain size that is at least 50 nm.

108. The stack of any one of claims 1-107, wherein the layer comprising an oxide comprises lithium-stuffed garnet having a D₅₀ grain size that is at least 1 μm.
